(19) United States
(12) Patent Application Publication
(10) Pub. No.: US 2011/0242855 A1
(43) Pub. Date: Oct. 6, 2011

(54) Power Converter

(75) Inventor: Dragan Jovcic, Aberdeenshire (GB)

(73) Assignee: University Court of the University of Aberdeen, Aberdeen, Aberdeenshire (GB)

(21) Appl. No.: 13/062,943

(22) PCT Filed: Sep. 9, 2009
(86) PCT No.: PCT/GB2009/051141

§ 371 Date: Jun. 22, 2011

(30) Foreign Application Priority Data
Sep. 9, 2008 (GB) 0816455.0

(51) Int. Cl. H02M 3/335

(52) U.S. Cl. 363/17

(57) ABSTRACT

A DC-DC power converter (130) for transferring power between low voltage terminals (26) and high voltage terminals (28). The converter comprises a low voltage circuit (132) connectable to the low voltage terminals (26), a high voltage circuit (134) connectable to the high voltage terminals (28); and at least one capacitor (Cᵣ) common to the low and high voltage circuits. Each of the circuits comprises an inductor (L₁/L₂) and switches (T₁-T₄/T₅-T₆) arranged to connect the capacitor(s) in series with the respective inductor, with alternating polarity, to form a resonant LC connection across the respective voltage terminals. The switches in each circuit include at least one set of switches (T₁,T₂/T₅,T₆) which, when actuated, allow current flow at the respective voltage terminals in a first direction; and the switches in at least one of the circuits include a further set of switches (T₃, T₄/T₇,T₈), which, when actuated, allow current flow at the respective voltage terminals in a second direction. The converter also comprises selecting means (72,74) for selecting one of the sets of switches in the or each circuit where two sets are provided, to select the direction of current at the respective voltage terminals, and thereby control the direction of power transfer between the low and high voltage terminals. The converter also comprises control means (140, 142 and 140, 144) for actuating the (selected) set of switches in both circuits, to repeatedly connect the capacitor(s) to the respective inductors, to thereby allow power transfer between the low voltage terminals and the capacitor, and between the capacitor and the high voltage terminals.

The present invention relates to a circuit for a DC-DC (direct current to direct current) power converter, and specifically a bidirectional power converter.

DC-DC power converters are widely used in low power electronics, and many different topologies exist. However, DC-DC converters are not widely used at power levels in the range of tens and hundreds of MW. In general, lower power DC-DC converters can not simply be scaled up for use at MW power levels, due to a lack of suitable switches operable at higher powers, and due to limits on the operating frequency. In any case, there has traditionally been little market need for DC-DC power conversion at these power levels.

However, in recent years, the market demand for DC-DC connection has significantly increased with the increasing numbers of power sources that generate DC [1,2]. These include fuel cells, photovoltaics, batteries, redox flow and thermoelectric sources. In addition, variable speed machines such as permanent magnet wind generators and small hydro generators may be viewed as DC sources if the last converter stage is removed [3]. Furthermore, most electrical storage and load leveling devices use DC storage media such as batteries, capacitors, supercapacitors and superconducting magnetic energy storage. Many of these DC sources utilise very low voltage basic cells or require wide variation of DC voltage, which means that their integration into the power grid has traditionally been difficult.

The recent rapid development of high voltage DC transmission technologies has also driven demand for DC-DC converters at higher powers. The recently developed HVDC (High Voltage Direct Current) light [4] has already been implemented in many interconnections and is being promoted as a solution for the integration of renewable power sources.

Given the increasing number of power systems involving DC sources and the increasing preference for DC transmission, there is now a demand for high ratio DC voltage stepping at MW power levels. A suitable MW size DC-DC converter would also aid in the development of multi-terminal HVDC.

Conventional, simple boost converters [5] can not achieve stepping ratios higher than around 2-4, and can not be used at MW power levels because of difficulties with the output diode reverse recovery, switch stresses and the negative influence of parasitic elements when operating at extreme duty ratios.

Conventionally, flyback or forward converters [5-7] are used where higher stepping ratios are required. However, such converters employ an intermediate AC transformer which significantly increases the complexity, weight and cost of the device. Moreover, such converters have further limitations associated with switch utlisation and internal losses.

There have been attempts to develop converters with internal AC transformers for use at higher power levels. However, some serious inherent limitations in terms of stepping ratios and power levels have been demonstrated [8].

Reference [1] discusses scaling up to 5 kW with a stepping ratio of 5, whilst reference [2] describes a 100 kW, 14 kV forward converter. However these converters utilize MOSFETs as switches with a very high operating frequency of around 10 kHz, which gives little prospect for developing the converter for operation at MW power levels.

Switched capacitor converters have recently been proposed as a method of achieving high boost without transformers [9]. However, the converters discussed in reference [9] are modular, where each module increases the output voltage only by the value of the input voltage. Accordingly, to achieve a stepping ratio of, for example, 10, 9 modules would be needed, which would require over 18 switches, resulting in significant losses and a highly complex circuit.

The family of resonant converters discussed in reference [10] have the potential for high power development since they are capable of operating with thyristor switches. Parallel resonant converters can also achieve high step-up ratios. However, these topologies have various limitations. Firstly, step-up operation can only be achieved in continuous mode, with consequent switching losses. Secondly, the input DC current has positive and negative intervals which implies poor power quality. Thirdly, it is difficult to reverse the direction of power transfer.

There is thus a demand for an improved DC-DC power converter that is operable at MW power levels.

There is also a demand for a high power DC-DC converter in which the direction of power transfer can be reversed to be operable in both step-up and step-down modes. A converter capable of power reversal may be required, for example, in utility applications when connecting to a high voltage DC grid or with energy storage applications.

Moreover, in practical applications, a DC-DC power converter may be required to connect to a DC network with a constant DC voltage, ie, where the voltage polarity can not change, as is the case, for example, in large DC networks. Alternatively, a DC-DC converter may be required to connect to a network with constant DC current, such as the DC side of a single thyristor-based current-source AC-DC converter. It is therefore desirable for a DC-DC converter to be capable of changing either voltage or current polarity to reverse the direction of power transfer through the converter.

In addition, it is desirable in the context of high power electronics for power converters to be fault tolerant. In this respect, tolerance of short circuit faults is of enormous importance for high-power electronics, since high power units are modular with numerous components, and any requirement for overvoltage or overcurrent rating results in significant cost penalties. Thus, in general, it is not economically justifiable to significantly overrate components in order to withstand fault conditions in high power applications.

There are currently no commercially accepted DC circuit breakers in high power electrical systems. Instead, DC faults are generally cleared with AC-side circuit breakers. Alternatively, in some circumstances, converters may be designed to operate under fault conditions (rectifiers only).

There is therefore a demand for a fault tolerant high power DC-DC power converter.

According to a first aspect of the invention, there is provided a DC-DC power converter for transferring power from low voltage terminals to high voltage terminals, and/or for transferring power from high voltage terminals to low voltage terminals, the converter comprising:—

a low voltage circuit connectable to the low voltage terminals;

a high voltage circuit connectable to the high voltage terminals; and

at least one capacitor common to the low and high voltage circuits;

wherein each of the low and high voltage circuits comprises an inductor and a plurality of switches arranged to connect the respective inductor in series with the or each capacitor, and to alternate the polarity with which the or each capacitor is connected to the respective inductor, to form a resonant LC connection across the respective voltage terminals;

wherein the plurality of switches in each of the low and high voltage circuits include at least one set of switches which, when actuated, allow current flow at the respective voltage terminals in a first direction;

and wherein the switches in at least one of the low and high voltage circuits include a further set of switches, which, when actuated, allow current flow at the respective voltage terminals in a second direction;

the converter further comprising:—

selecting means for selecting one of the sets of switches in the or each circuit where two sets of switches are provided, to select the direction of current at the respective voltage terminals, and thereby control the direction of power transfer between the low and high voltage terminals;

control means for actuating the set of switches or the selected set of switches in the low voltage circuit at a predetermined frequency and at predetermined phase angles, to repeatedly connect the capacitor, or each capacitor in turn, to the respective inductor with alternating polarity, to thereby allow power transfer from the low voltage terminals to the capacitor(s), and/or to allow power transfer from the capacitor(s) to the low voltage terminals; and

control means for actuating the set of switches or the selected set of switches in the high voltage circuit at a predetermined frequency and at predetermined phase angles, to repeatedly connect the capacitor, or each capacitor in turn, to the respective inductor with alternating polarity, to thereby allow power transfer from the capacitor(s) to the high voltage terminals and/or to allow power transfer from the high voltage terminals to the capacitor(s).

Thus, with the present invention, the current direction in either or both of the low and high voltage circuits can be changed independently of the current direction in the other circuit. That is to say, the current at the respective voltage terminals can be changed, whilst the direction of current in the capacitor(s) is alternated.

This allows the converter to be used as a bidirectional converter (ie, power may be transferred in either direction through the converter), in cases where the voltage polarity can not be changed at one or both of the low and high voltage terminals. That is to say, the converter may be operated in both a first mode (for step up operation) and a second mode (for step down operation), although it is envisaged that the converter may be configured for use in only one of the first and second modes.

In order to reverse the direction of power transfer through a converter, it is necessary to change either the current direction or the voltage polarity at both the high and low voltage terminals. This may be achieved externally of the converter, by changing the voltage polarity at both terminals. However, this is not possible in cases where the voltage polarity at the terminals in question is fixed. For example, if the converter is connected to a large DC network. With the converter of the present invention, the direction of current flow in either or both of the low and high voltage circuits (and thus through the respective voltage terminals) can be changed by actuating the appropriate set of switches, such that the direction of power transfer can be reversed in cases where the voltage polarity at either or both terminals can not be changed.

Moreover, as demonstrated below, the converter is able to achieve fast reversal in the direction of power transfer.

The current/voltage polarity reversal occurs substantially simultaneously in both circuits. However, the selection of either voltage or current reversal in each of the low and high voltage circuits is independent of the selection made in the other circuit.

The converter of the present invention comprises two sets of switches for current polarity reversal in at least one of the low and high voltage circuits. However, preferably, both the low and high voltage circuits include two sets of switches, such that current polarity can be changed at both voltage terminals if required.

The choice between voltage or current reversal at the low and high voltage terminals may be made depending on the circumstances. Although the converter of the present invention is able to change the current direction at either or both of the low and high voltage terminals, the direction of power transfer may still be reversed by reversing the voltage polarity at both the low and high voltage terminals where appropriate to the circumstances. For example, if the converter is connected between two constant DC current networks.

The converter of the present invention may be used to transfer power in cases where the voltage level at the “low” voltage terminals is substantially equal to the voltage level at the “high” voltage terminals, ie, V₁=V₂. For example, such a converter may be used as a fault current limiter, where voltage stepping is not required.

With the converter of the present invention, the capacitor(s) is/are the main energy storage component. Accordingly, the size of the inductors is determined by the harmonic level required and is typically considerably smaller than that required for a comparable, conventional step-up converter. Further, the size of the inductors required will typically be several times smaller than a comparable AC transformer. This, makes the converter of the present invention considerably cheaper and more practical than previous solutions for transferring power at high power levels.

The converter of the present invention also has an inherently good tolerance to faults, whilst certain embodiments of the invention are fully fault tolerant.

The control means is preferably configured to actuate the switches of the or the selected set of switches in each circuit at a predetermined operating frequency fₛ and at predetermined phase angles to alternate the polarity of the or each capacitor, independently in each circuit.

That is to say, the control means is preferably configured to determine the firing instants (the instants at which the switches are actuated) for the or the selected set of switches in each circuit on the basis of a controllable operating frequency and controllable phase angle. The switches in the low voltage circuit may be controlled by frequency variation. The phase angles may be set to 0 degrees and 180 degrees, and it is these angles which determine the firing instants for the switches. The switches of the high voltage circuit may be operated with the same frequency as those of the low voltage converter, whilst the switches are actuated at predetermined angles which, in general, are not 0 degrees.

Thus, the control means preferably enables operation of both circuits at a common frequency, whilst the phase angles for each circuit are preferably controlled independently of the other circuit.

In the low voltage circuit, the phase angles are 0 degrees and 180 degrees, and predetermined values of α and α+180° for the high voltage circuit. Frequency and phase are related through ω=dθ/dt, such that both are affected if one changes.

Where the converter comprises more than one common capacitor, the control means is preferably configured to repeatedly connect each capacitor to the respective inductor in turn and with alternating polarity.

With the converter of the present invention, the switches of the low and high voltage circuits require forward and reverse blocking capability. Symmetrical switches such as thyristors are therefore preferred. The use of thyristors makes the converter suitable for use at MW power levels. However, other types of switch, such as MOSFETs, may be used in lower power applications. As MOSFETs are asymmetrical switches, they must be used with a series diode.

In general, the switches of the high and low voltage circuits preferably comprise unidirectional switches, for example, thyristors. Where two sets of switches are present in a circuit, the two sets of switches are preferably two sets of unidirectional switches connected together in antiparallel. Each pair of unidirectional switches connected together in antiparallel forms a bidirectional switch. More generally, any suitable bidirectional switches may be used.

The switches of both the low and high voltage circuits are preferably connected in the respective circuit as two or more branches, each branch comprising at least one pair of unidirectional switches connected together in series with the same orientation. These switches correspond to the at least one set of switches mentioned above.

Each branch in one of the low and high voltage circuits may comprise a single pair of unidirectional switches. In this case, the direction of current flow in the respective circuit can not be reversed. Accordingly, the polarity of the voltage at the respective voltage terminals must be reversed in order to reverse the direction of power transfer.

Each branch in one or both of the low and high voltage circuits may comprise a first pair of series connected unidirectional switches connected in antiparallel with a second pair, to form a pair of bidirectional switches connected together in series. The second pair of switches correspond to the second set of switches mentioned above. In this case, the direction of current flow in the respective circuit will depend on which pair of switches is actuated, such that the direction of current flow in the respective circuit can be reversed when required for reversal of the direction of power transfer.

In general, the converter may have n_{b} branches in each circuit (where n_{b}>1) and n_{c} capacitors connected between the branches, where the number of branches is related to the number of capacitors by equation (38):

n_{c}=(n_{b}−1)n_{b}/2 (38)

The converter may be referred to as an “n_{b}-branch” converter, where n_{b} is the number of branches in each circuit.

From equation (38) it can be seen that, for a 2-branch converter, n_{c}=1. In this case, the low and high voltage circuit switches will be respectively arranged as a first branch and a second branch, the single capacitor being connected between the first and second branches in each circuit.

It will be appreciated that a 2-branch converter represents the simplest structure possible with the present invention, since it will require the lowest number of switches, and only one common capacitor.

Nevertheless, a more complex converter, where n_{b}>2, may be appropriate. In this respect, for example, the size and weight of the low voltage circuit inductor can be reduced if the switching frequency fₛ is increased. However, the switching frequency fₛ achievable with a single capacitor is limited by the turn-off time for the switches. Accordingly, if a reduction in the size of the low voltage circuit inductor is required, it may be desirable to increase the switching frequency fₛ beyond the maximum achievable with a single capacitor, which is limited by the turn-off time for the switches. This can be achieved by providing multiple capacitors for sequential connection to the inductor, such that the inductor supplies the capacitors in sequence, and thus allows for higher switching frequencies. As can be seen from equation (38), additional converter branches are required in order to connect multiple capacitors. The maximum switching frequency fₛₙₐₓ is related to the number of branches by equation (37):

fₛₘₐₓ=(2(n_{b}−2)+1)/2T_{off} (37)

where T_{off} is the maximum turn off time for the switches.

From equation (38), it can be seen that, for a 3-branch converter, n_{c}=3. In this case, the switches of the low and high voltage circuits may be respectively arranged as first, second and third branches, a first capacitor being connected between the first and second branches in each circuit, a second capacitor being connected between the first and third branches in each circuit, and a third capacitor being connected between the second and third branches in each circuit.

More generally, in the case of an n_{b}-branch converter, a capacitor will be connected between each branch and every other branch in the low voltage circuit, the or each capacitor being connectable between corresponding pairs of branches in the high voltage circuit.

Where n_{c}>1, the capacitors may be Delta connected. Alternatively, they may be Y connected.

The converter may further comprise fault control means for interrupting or limiting power transfer during a fault at either or both of the low and high voltage terminals. The aim of the fault control system is to prevent fault current propagation through the converter.

The high voltage circuit inductor and/or the low voltage circuit inductor may be selected to ensure sufficient thyristor turn off time during fault conditions. Such design maintains controllability of the converter and allows sufficient time for the fault interrupting control means to react to a fault.

The construction of the converter of the present invention inherently possesses good fault tolerance because, by providing an inductor in both of the low and high voltage circuits, the capacitor(s) are prevented from discharging to fault instantaneously. The rate at which the capacitor(s) discharge is dependent on the size of the inductors. The values of the inductors may therefore be selected to allow half resonant cycle period to be larger than the turn off time required for particular switches. This provides complete immunity from faults, including zero impedance faults at the low and high voltage terminals.

The high voltage circuit of the converter may comprises a first inductor for use when operating in the first mode (step up mode), and a second inductor for use when operating in the second mode (step down mode).

The low voltage circuit may comprise a filter circuit. For example, an LC filter comprising a filter inductor and a filter capacitor connected across the low voltage terminals, to reduce the harmonic content.

Similarly, the high voltage circuit may comprise a filter circuit. For example, an LC filter comprising a filter inductor and a filter capacitor connected across the high voltage terminals, to reduce the harmonic content.

According to a second aspect of the present invention, there is provided a DC-DC power converter for transferring power from low voltage terminals to high voltage terminals, and/or for transferring power from high voltage terminals to low voltage terminals, the converter comprising:—

a low voltage circuit connectable to the low voltage terminals;

a high voltage circuit connectable to the high voltage terminals; and

at least one capacitor common to the low and high voltage circuits;

wherein each of the low and high voltage circuits comprises an inductor and a plurality of switches arranged to connect the respective inductor in series with the or each capacitor, and to alternate the polarity with which the or each capacitor is connected to the respective inductor, to form a resonant LC connection across the respective voltage terminals;

the converter further comprising:—

control means for actuating the switches in the low voltage circuit at a predetermined frequency and at predetermined phase angles, to repeatedly connect the capacitor, or each capacitor in turn, to the respective inductor with alternating polarity, to thereby allow power transfer from the low voltage terminals to the capacitor(s) in said first mode of operation, and/or to allow power transfer from the capacitor(s) to the low voltage terminals in said second mode of operation; and

control means for actuating the switches in the high voltage circuit at a predetermined frequency and at predetermined phase angles, to repeatedly connect the capacitor, or each capacitor in turn, to the respective inductor with alternating polarity, to thereby allow power transfer from the capacitor(s) to the high voltage terminals and/or to allow power transfer from the high voltage terminals to the capacitor(s).

With the converter of this aspect of the invention, the switches in each of the high and low voltage circuits preferably comprise unidirectional switches which, when actuated, allow current flow in a single direction in the respective circuit.

The converter may thus be a unidirectional step-up (first mode) or step-down (second mode) converter, where reversal of the current direction in the low and high voltage circuits is not required. It may also be a bidirectional converter operable in either mode, wherein reversal of the direction of power transfer is achieved by reversing the voltage polarity at both the low and high voltage terminals.

Moreover, the converter may be used to transfer power in cases where the voltage level at the “low” voltage terminals is substantially equal to the voltage level at the “high” voltage terminals, ie, V₁=V₂. For example, such a converter may be used as a fault current limiter, where voltage stepping is not required.

According to a third aspect of the present invention, there is provided a DC-DC power converter for transferring power from low voltage terminals to high voltage terminals, and/or for transferring power from high voltage terminals to low voltage terminals, the converter comprising:—

a low voltage circuit connectable to the low voltage terminals;

a high voltage circuit connectable to the high voltage terminals; and

n_{c} capacitors common to the low and high voltage circuits;

wherein each of the low and high voltage circuits comprises an inductor and a plurality of switches arranged to connect the respective inductor in series with each capacitor in turn, and to alternate the polarity with which each capacitor is connected to the respective inductor, to form a resonant LC connection across the respective voltage terminals;

the converter further comprising:—

control means for actuating the switches in the low voltage circuit at a predetermined frequency and at predetermined phase angles, to repeatedly connect each capacitor in turn to the respective inductor with alternating polarity, to thereby allow power transfer from the low voltage terminals to the capacitors in said first mode of operation, and/or to allow power transfer from the capacitors to the low voltage terminals in said second mode of operation; and

control means for actuating the switches in the high voltage circuit at a predetermined frequency and at predetermined phase angles, to repeatedly connect each capacitor in turn to the respective inductor with alternating polarity, to thereby allow power transfer from the capacitors to the high voltage terminals and/or to allow power transfer from the high voltage terminals to the capacitors;

wherein n_{c} is greater than one.

The number of branches is preferably related to the number of capacitors by equation (36):

n_{c}=(n_{b}−1)n_{b}/2 (36)

By providing more than one capacitor, the switching frequency of the converter can be increased beyond that achievable with a single capacitor, and thereby allows for a reduction in the size of the inductor in the low voltage circuit.

The converter of this aspect of the present invention may comprise either unidirectional or bidirectional switches in each of the low and high voltage circuits. The converter may thus be a bidirectional converter wherein power transfer direction can be reversed by reversing either the current direction (where bidirectional switches are present) or the voltage polarity in each circuit, or a unidirectional step-up or step-down converter, where reversal of the current direction in the low and high voltage circuits is not required.

The converter of this aspect of the present invention may also be used to transfer power in cases where the voltage level at the “low” voltage terminals is substantially equal to the voltage level at the “high” voltage terminals, ie, V₁=V₂. For example, such a converter may be used as a fault current limiter, where voltage stepping is not required.

According to a first aspect of the present invention, there is provided a DC-DC power converter for transferring power between low voltage terminals and high voltage terminals, the converter comprising:—

a low voltage circuit connectable to the low voltage terminals;

a high voltage circuit connectable to the high voltage terminals; and

one or more capacitors common to the low and high voltage circuits;

each of the low and high voltage circuits comprising an inductor and a plurality of switches arranged to connect the or each capacitor in series with the inductor to form a resonant LC connection across the respective voltage terminals, and to alternate the polarity of the or each capacitor in relation to the inductor;

wherein the switches in each of the low and high voltage circuits include at least one set of switches which, when actuated, allow current flow in a first direction, and wherein the switches in at least one of the low and high voltage circuits include a further set of switches which, when actuated, allow current flow in a second direction,

the converter further comprising:—

control means for selecting one of the sets of switches for the or each circuit where two sets are present to select the direction of current flow in the respective circuit, and for actuating the switches of the or the selected set of switches in each circuit, at a predetermined frequency and at predetermined phase angles, for repeated connection of the or each capacitor to the respective inductor with alternating polarity, to allow current to flow in each circuit in the first or a selected one of the first and second directions, and thereby enable power transfer between the low and high voltage terminals.

That is to say, a DC-DC power converter for transferring power between low voltage terminals and high voltage terminals in each direction, the converter comprising:—

a low voltage circuit connectable to the low voltage terminals; and

a high voltage circuit connectable to the high voltage terminals; and

one or more capacitors common to the low and high voltage circuits;

each of the low and high voltage circuits comprising an inductor and a plurality of switches arranged to connect the capacitor, or each capacitor in turn, in series with the inductor, allowing terminal current in one direction, while repeatedly alternating direction of current in the, or each capacitor to form a resonant LC connection across the respective voltage terminals;

wherein the switches in each of the low and high voltage circuits include at least one set of switches which, when actuated, allow terminal current flow in a first direction, and wherein the switches in at least one of the low and high voltage circuits include a further set of switches which, when actuated allow terminal current flow in a second direction,

the converter further comprising:—

control means for selecting one of the sets of switches where two sets are present in the low voltage circuit, to select the direction of current in the terminals, and for repeatedly actuating switches at a predetermined frequency and phase angle, to alternate current in the, or in turn in each of the capacitors, thus enabling power flow between low voltage terminals and the common capacitor or capacitors,

control means for selecting one of the sets of switches where two sets are present in the high voltage circuit, to select the direction of current in the terminals and for repeatedly actuating switches at a predetermined frequency and phase angle, to alternate current in the, or in turn in each of the capacitors, thus enabling power flow between high voltage terminals and the common capacitor or capacitors, to thereby enable power transfer between low and high voltage terminals.

According to a second aspect of the present invention, there is provided a DC-DC power converter for transferring power between low voltage terminals and high voltage terminals, the converter comprising:—

a low voltage circuit connectable to the low voltage terminals;

a high voltage circuit connectable to the high voltage terminals; and

one or more capacitors common to the low and high voltage circuits;

each of the low and high voltage circuits comprising an inductor and a plurality of switches arranged to connect the or each capacitor in series with the inductor to form a resonant LC connection across the respective voltage terminals, and to alternate the polarity of the or each capacitor in relation to the inductor;

the converter further comprising:—

control means for actuating the switches in each circuit, at a predetermined frequency and at predetermined phase angles, for repeated connection of the or each capacitor to the respective inductor with alternating polarity to allow current flow in each circuit to thereby enable power transfer between the low and high voltage terminals.

That is to say, a DC-DC power converter for transferring power between low voltage terminals and high voltage terminals, the converter comprising:—

a low voltage circuit connectable to the low voltage terminals;

a high voltage circuit connectable to the high voltage terminals;

one or more capacitors common to the low and high voltage circuits;

each of the low and high voltage circuits comprising an inductor and a plurality of switches arranged to connect the capacitor, or to connect each capacitor in turn, in series with the inductor to form a resonant LC connection across the respective voltage terminals, to allow terminal current in one direction and to alternate direction of current in the or each capacitor;

the converter further comprising:—

control means for actuating the switches in each circuit, at a predetermined frequency and at predetermined phase angles, for repeated connection of the, or in turn in each, capacitor to the respective inductor with alternating polarity to allow current flow between each set of terminals and the common capacitor or capacitors, and thereby enable power transfer between low and high voltage terminals.

According to a third aspect of the present invention, a DC-DC power converter for transferring power between low voltage terminals and high voltage terminals, the converter comprising:—

a low voltage circuit connectable to the low voltage terminals;

a high voltage circuit connectable to the high voltage terminals; and

n_{c} capacitors common to the low and high voltage circuits;

each of the low and high voltage circuits comprising an inductor and a plurality of switches arranged for connecting each capacitor in series with the inductor to form a resonant LC connection across the respective voltage terminals, and for alternating the polarity of the or each capacitor with respect to the inductor;

the converter further comprising:—

control means for actuating the switches in each circuit, at a predetermined frequency and at predetermined phase angles, to repeatedly connect each capacitor in turn to the respective inductor with alternating polarity, to thereby enable power transfer between the low and high voltage terminals,

wherein n_{c} is greater than one.

That is to say, a DC-DC power converter for transferring power between low voltage terminals and high voltage terminals in each direction, the converter comprising:—

a low voltage circuit connectable to the low voltage terminals;

a high voltage circuit connectable to the high voltage circuit; and

n_{c} capacitors common to the low and high voltage circuits;

each of the low and high voltage circuits comprising an inductor and a plurality of switches arranged for connecting each capacitor in turn, in series with the inductor to form a resonant LC connection across the respective voltage terminals, to allow terminal current in one direction and to alternate direction of current in each capacitor;

the converter further comprising:—

control means for actuating the switches in each circuit, at a predetermined frequency and at predetermined phase angles, to repeatedly connect each capacitor in turn to the respective inductor with alternating polarity, to enable power transfer between the respective voltage terminals and the common capacitors and to thereby enable power transfer between the low and high voltage terminals,

wherein n_{c} is greater than one.

The present invention will now be described with reference to the following drawings in which:—

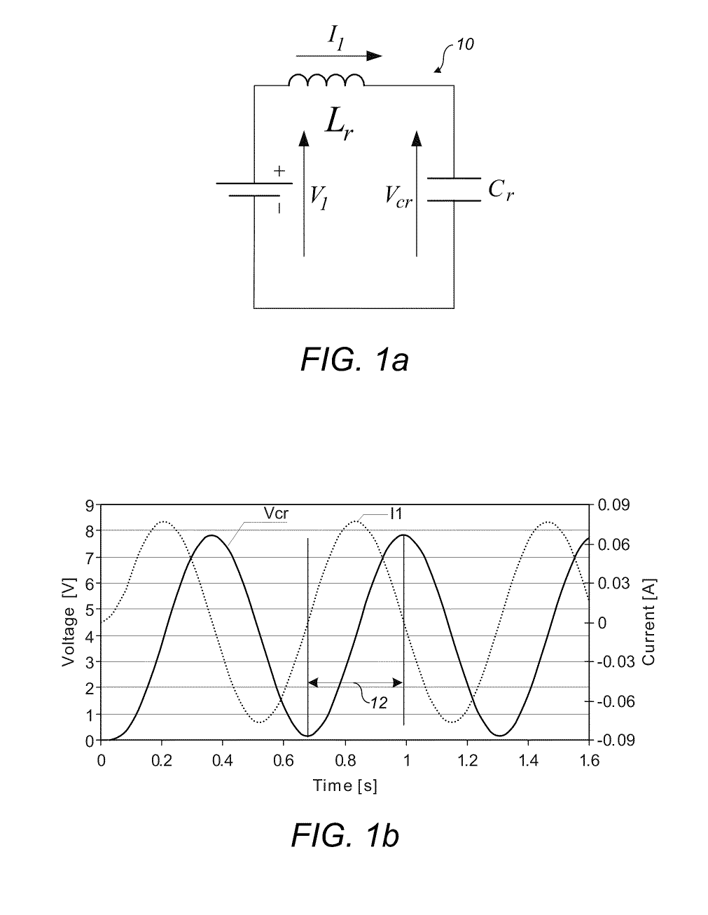

FIG. 1a shows a simple LC circuit;

FIG. 1b shows the variation of voltage V_{cr} and current I₁ with time for the LC circuit of FIG. 1a;

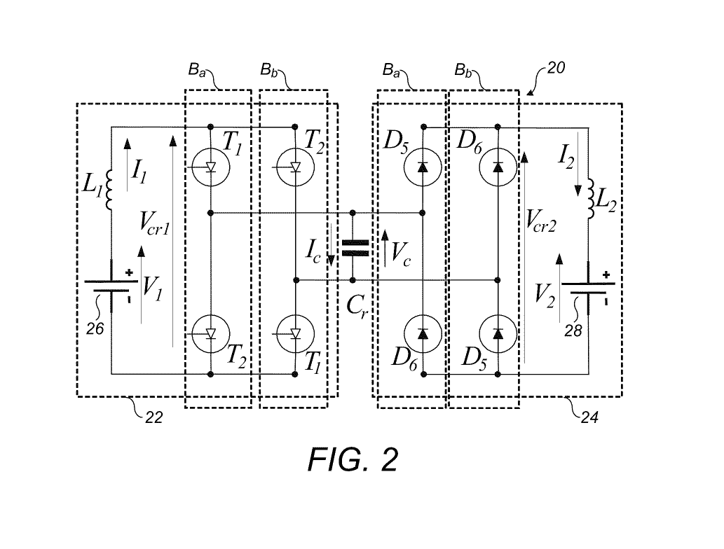

FIG. 2 shows the topology of a unidirectional step-up converter where V₁<V₂;

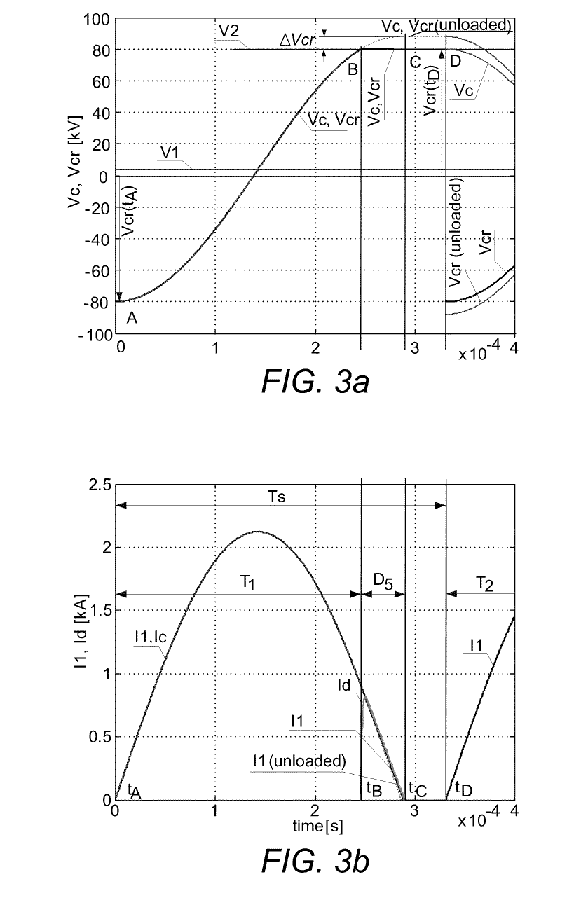

FIG. 3 shows converter variables in discontinuous mode, for the case of loaded and unloaded operation;

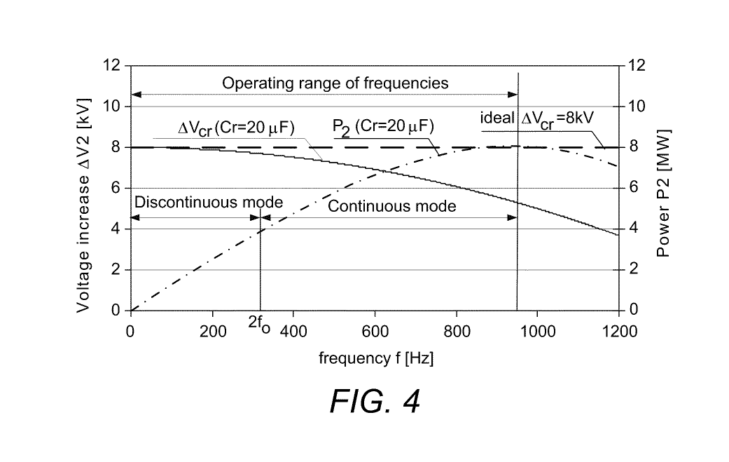

FIG. 4 shows, for the circuit of FIG. 2, the steady-state power P₂ and capacitor voltage rise ΔV_{c} as a function of the switching frequency fₛ in continuous operating mode, with V₁=4 kV and V₂=80 kV (both constant), and including switching and parasitic losses;

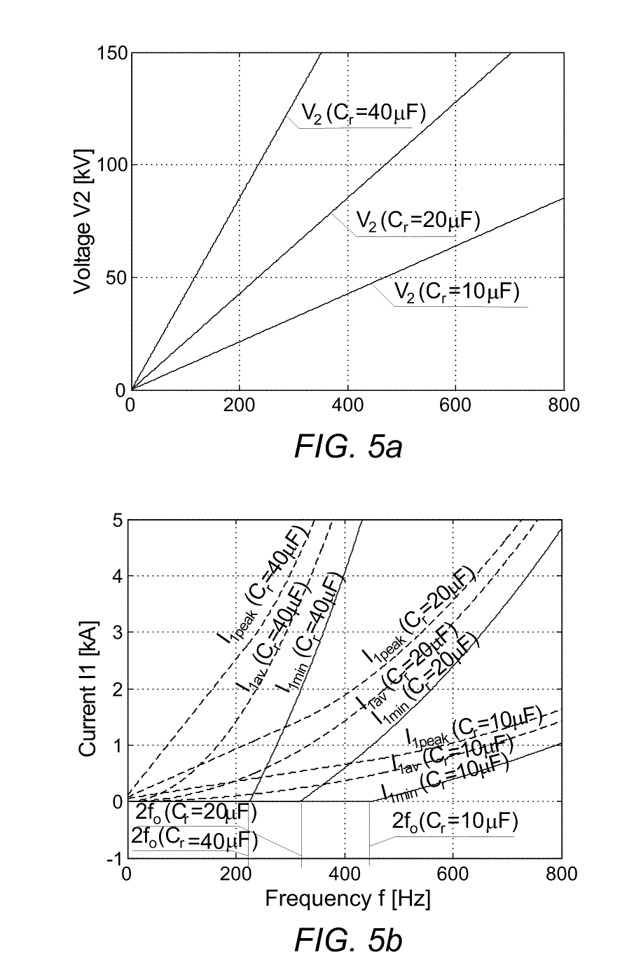

FIGS. 5a and 5b show, for the circuit of FIG. 2, the operating point as a function of switching frequency fₛ and capacitor size for a constant impedance load;

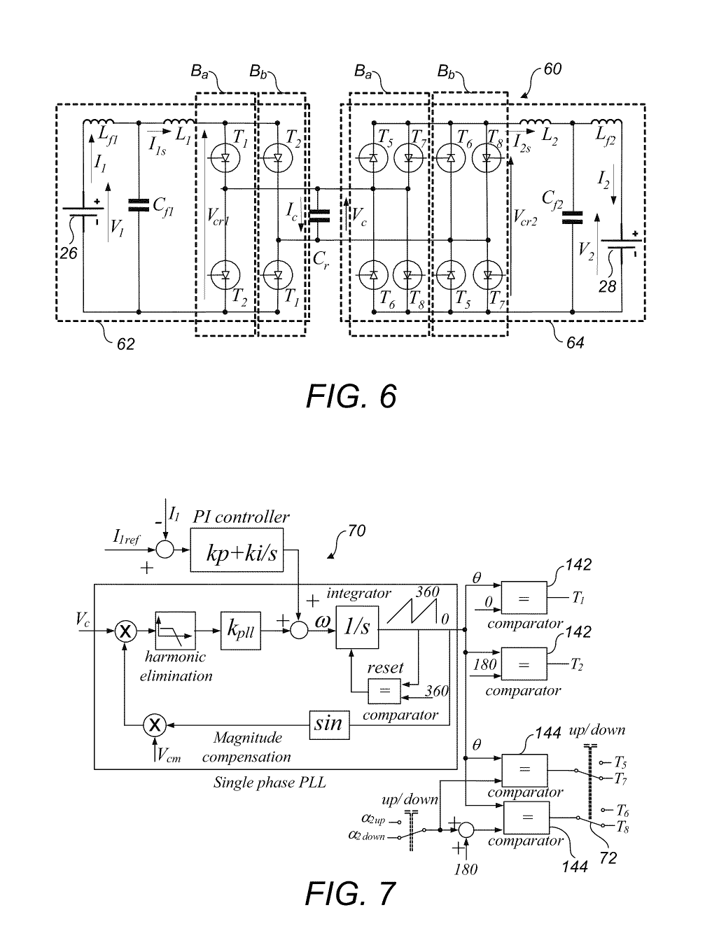

FIG. 6 shows the topology of a bidirectional converter which embodies the present invention (V₁<V₂), wherein power reversal may be achieved by changing the voltage polarity at the low voltage terminals, and the current polarity at the high voltage terminals;

FIG. 7 shows, in schematic form, a control system for both step-up and step-down operation of the bidirectional converter of FIG. 6;

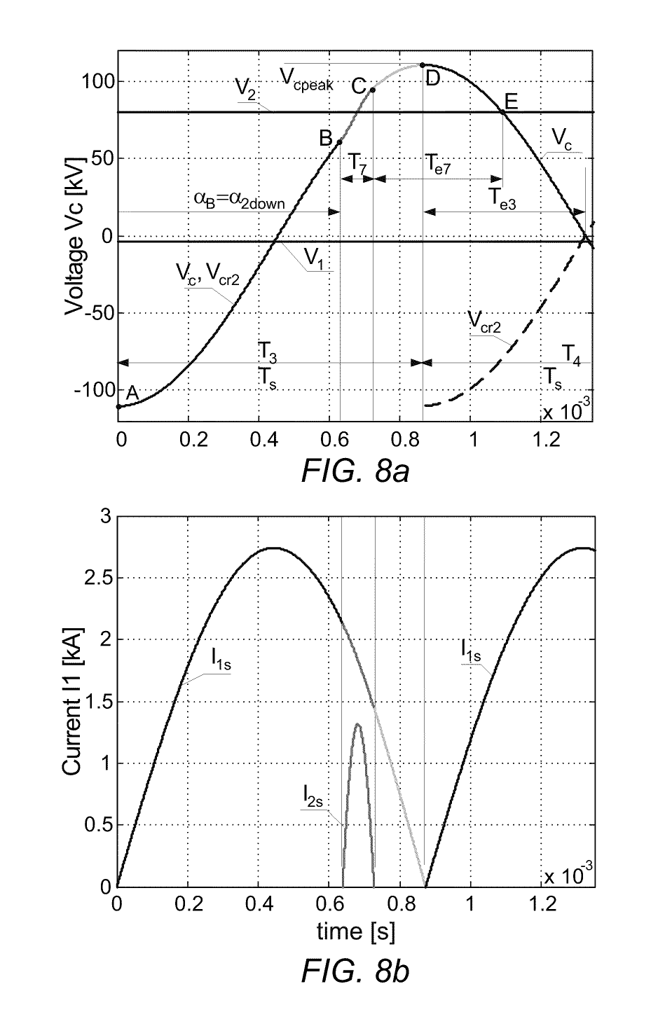

FIGS. 8a and 8b show various converter voltage and current waveforms for step-down operation of the bidirectional converter of FIG. 6;

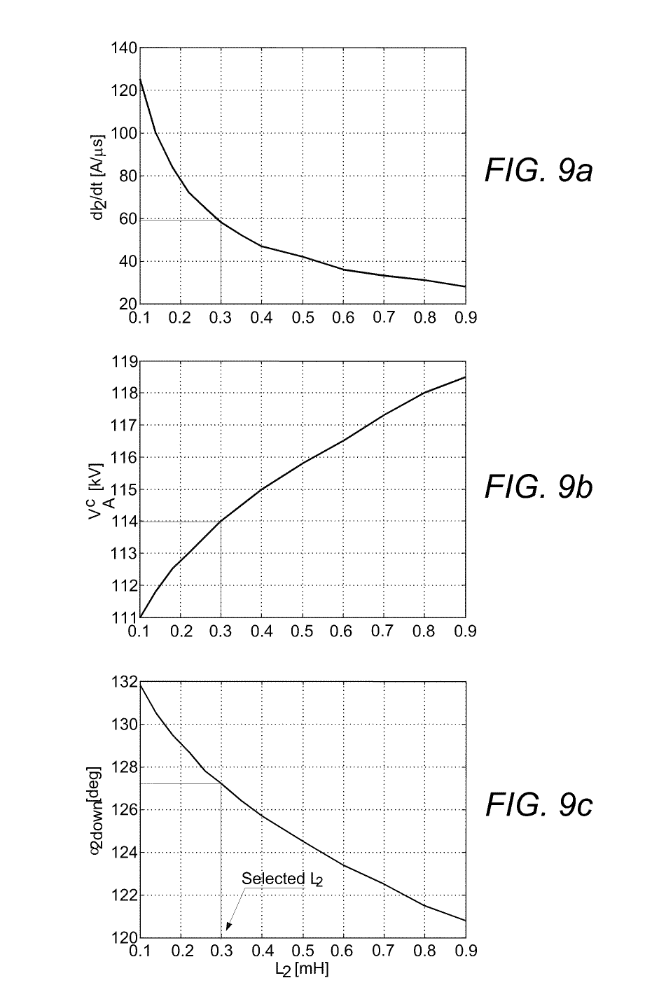

FIGS. 9a to 9c show the rate of change of current I₂ at the high voltage terminals, the voltage V_{c} across the rotating capacitor, and the high voltage side firing angle, α_{2down}, all as a function of the size of the inductor L₂ at the high voltage side;

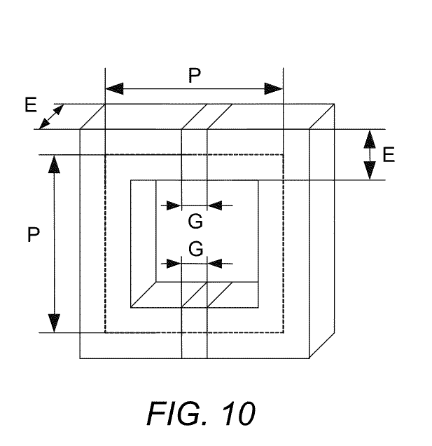

FIG. 10 illustrates the inductor core dimensions for the inductors L₁ and L₂;

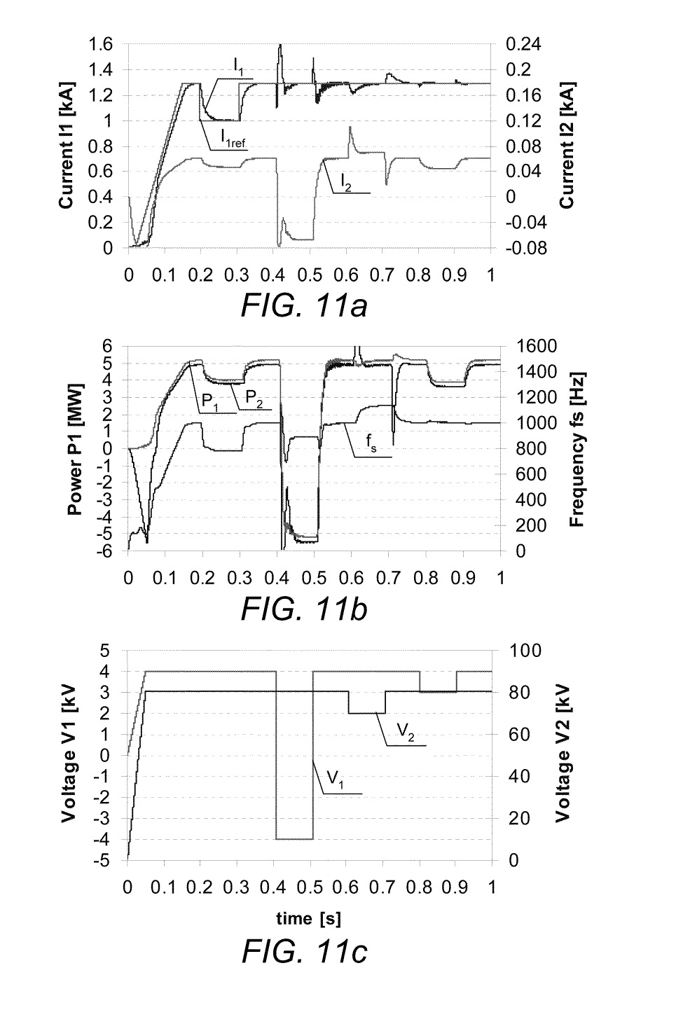

FIGS. 11a to 11c illustrate the PSCAD simulation results for the bidirectional converter of FIG. 6;

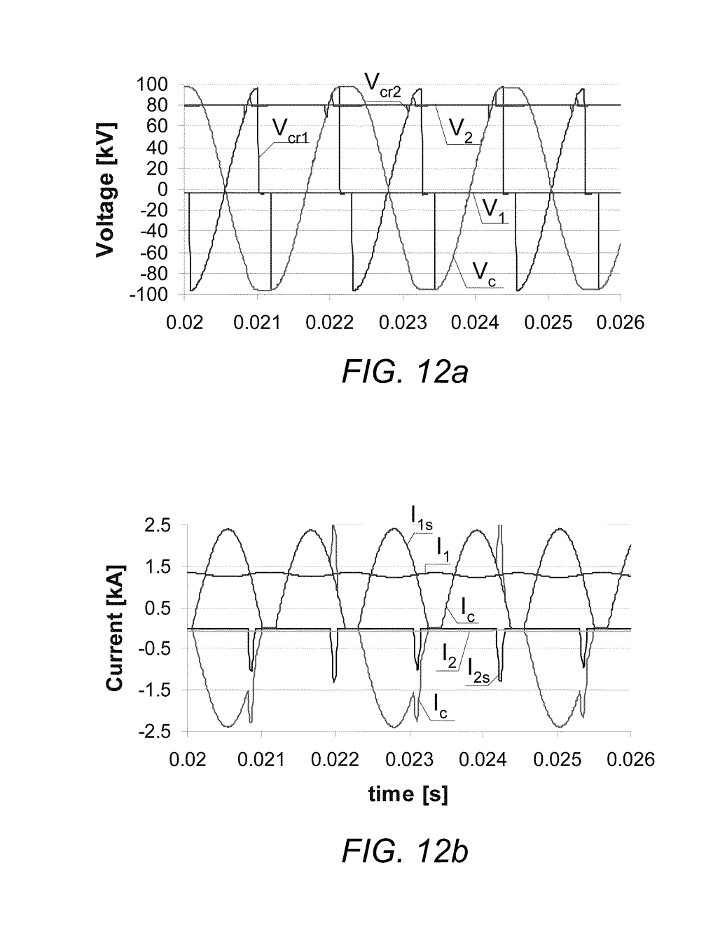

FIGS. 12a and 12b show detailed PSCAD simulation voltage and current traces for the bidirectional converter of FIG. 6, operating in step-down mode;

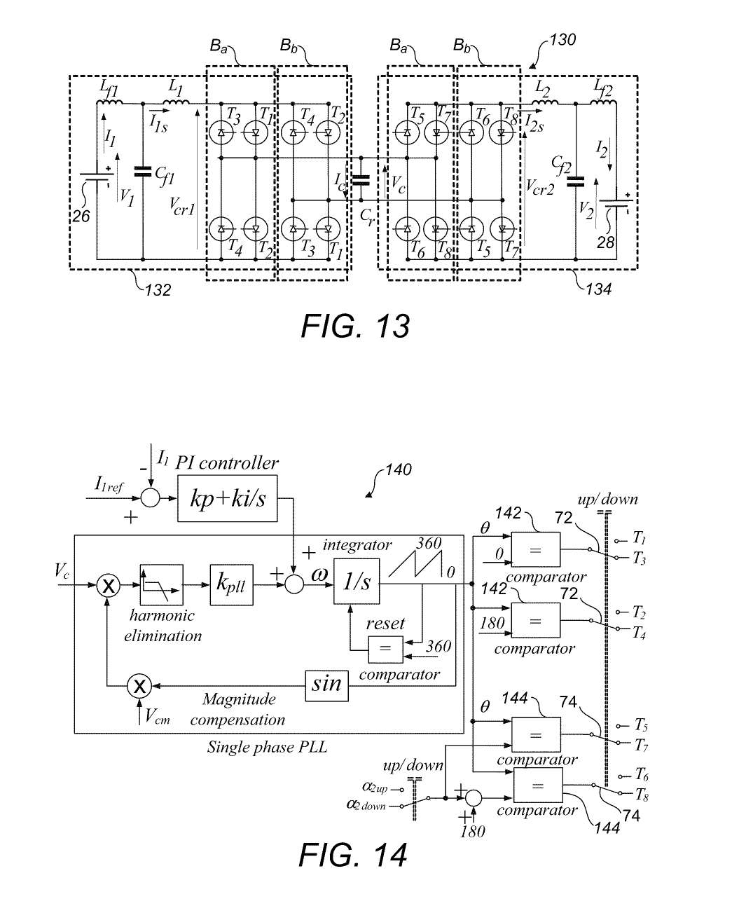

FIG. 13 shows the topology of a bidirectional converter which embodies the present invention, (V₁<V₂), wherein current polarity can be reversed at both the low and high voltage terminals;

FIG. 14 shows, in schematic form, the control system for both step-up and step-down operation of the bidirectional converter of FIG. 13;

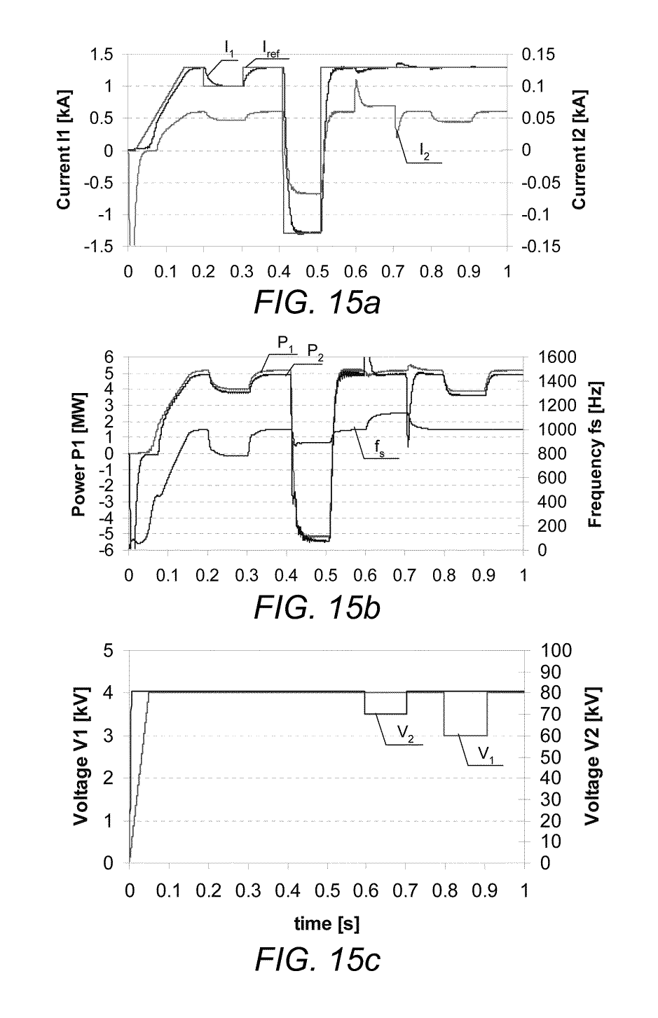

FIGS. 15a to 15c show the PSCAD simulation results for the bidirectional converter of FIG. 13;

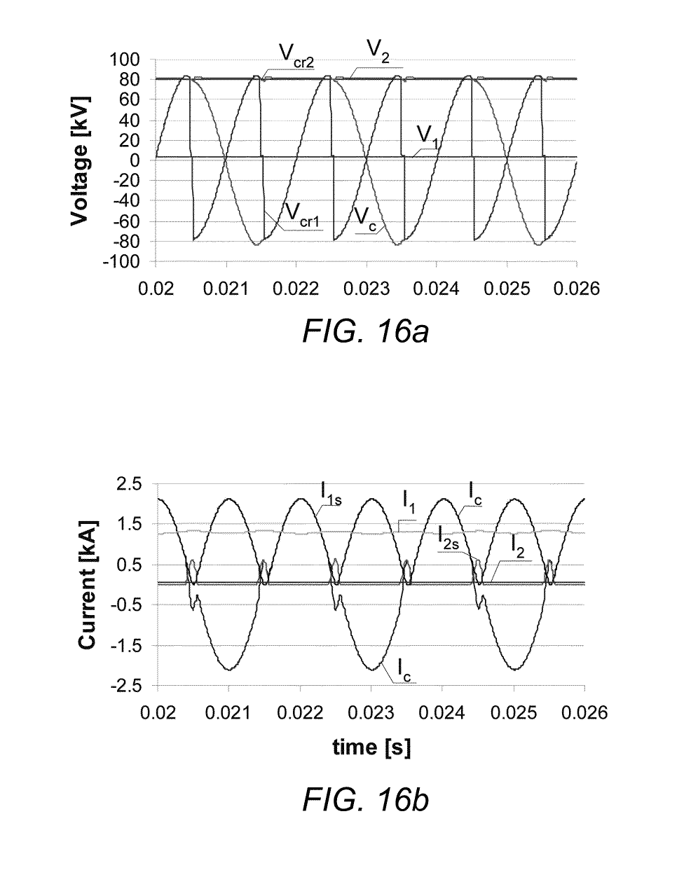

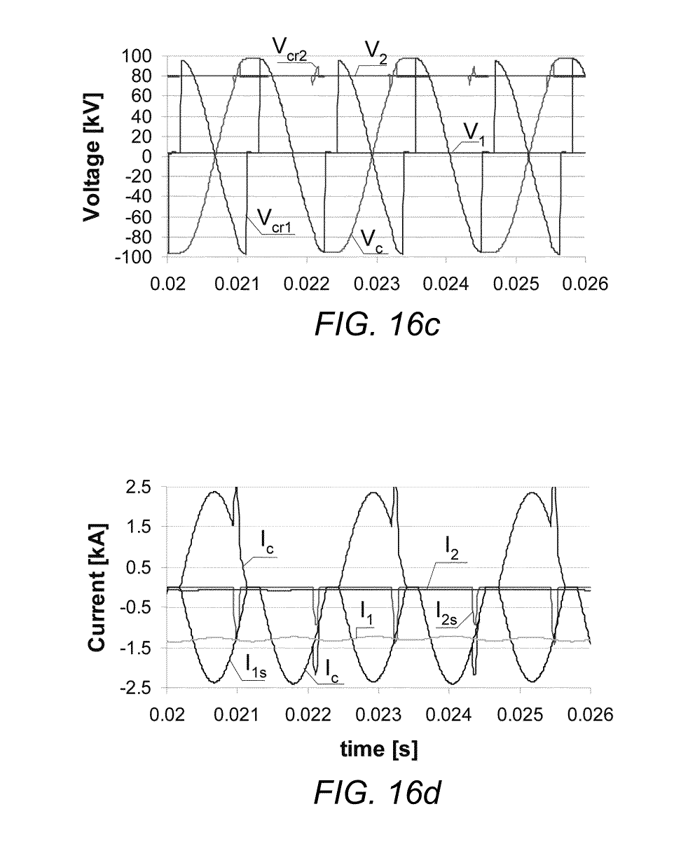

FIGS. 16a and 16b show detailed PSCAD simulation voltage and current traces for the bidirectional converter of FIG. 13, operating in step-up mode;

FIGS. 16c and 16d show detailed PSCAD simulation voltage and current traces for the bidirectional converter of FIG. 13, operating in step-down mode;

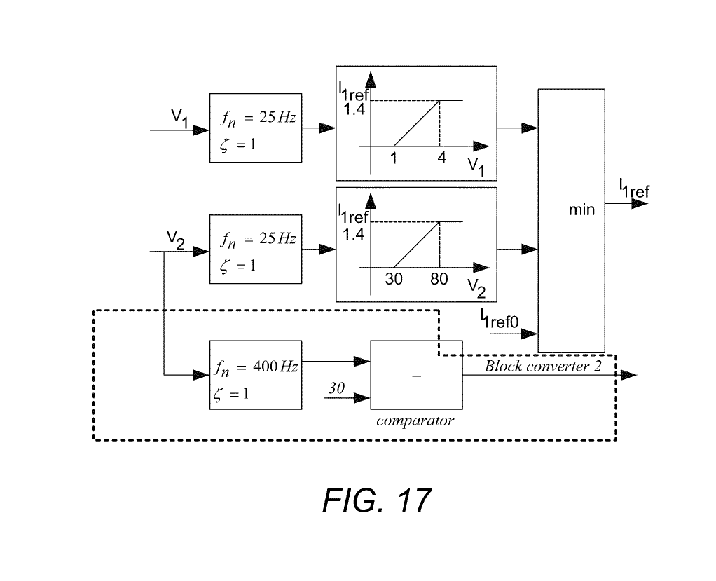

FIG. 17 shows, in schematic form, a fault current interruption control circuit, for use with the present invention;

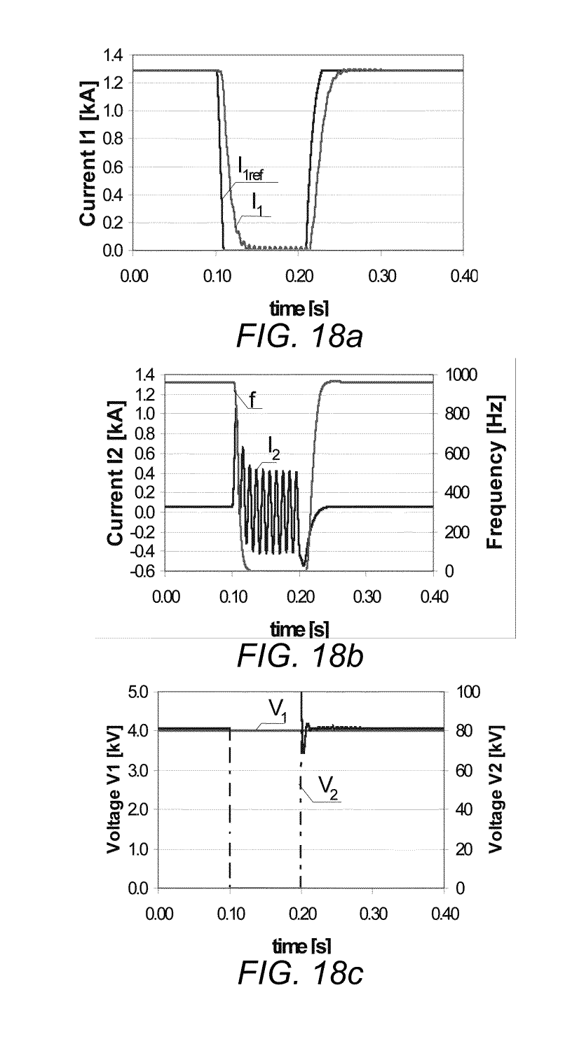

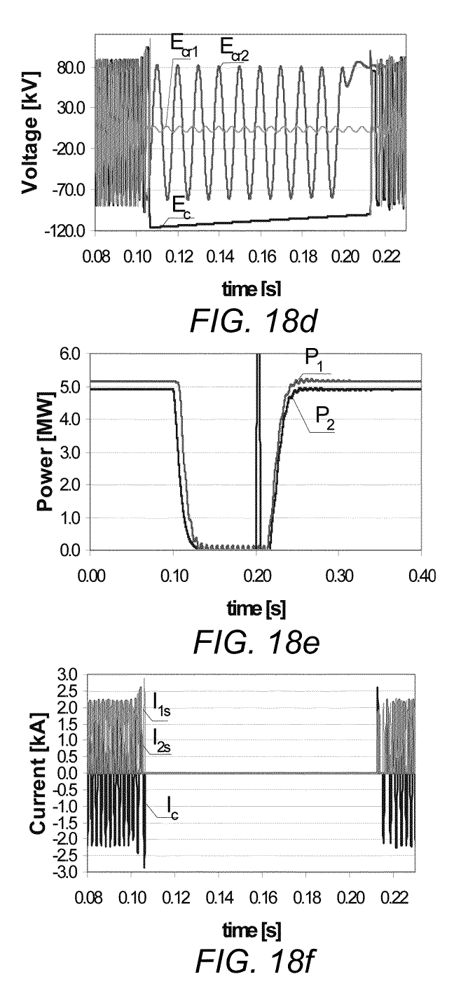

FIGS. 18a to 18f show the results of PSCAD simulations for fault interrupting tests performed using the converter of FIG. 13 with the fault interrupting control circuit of FIG. 17, for step-up operation and a 0.1 s fault on V₂, ie, fault B;

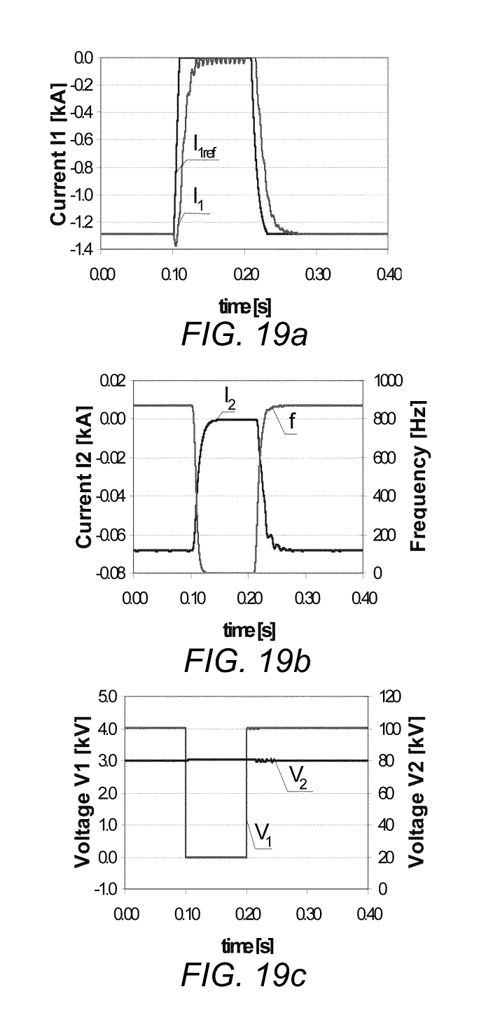

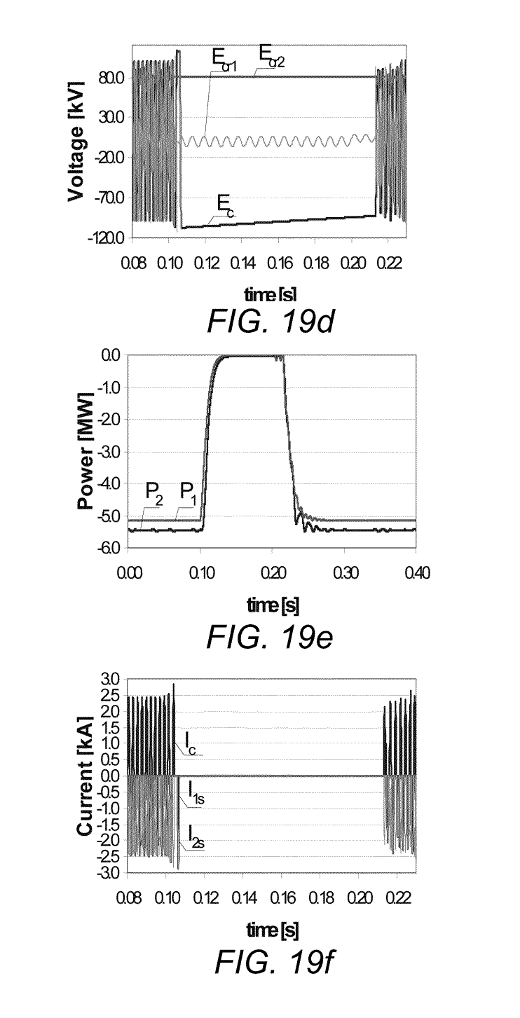

FIGS. 19a to 19f show the results of PSCAD simulations for fault interrupting tests performed using the converter of FIG. 13 with the fault interrupting control circuit of FIG. 17, for step-down operation and a 0.1 s fault on V₁, ie, fault C;

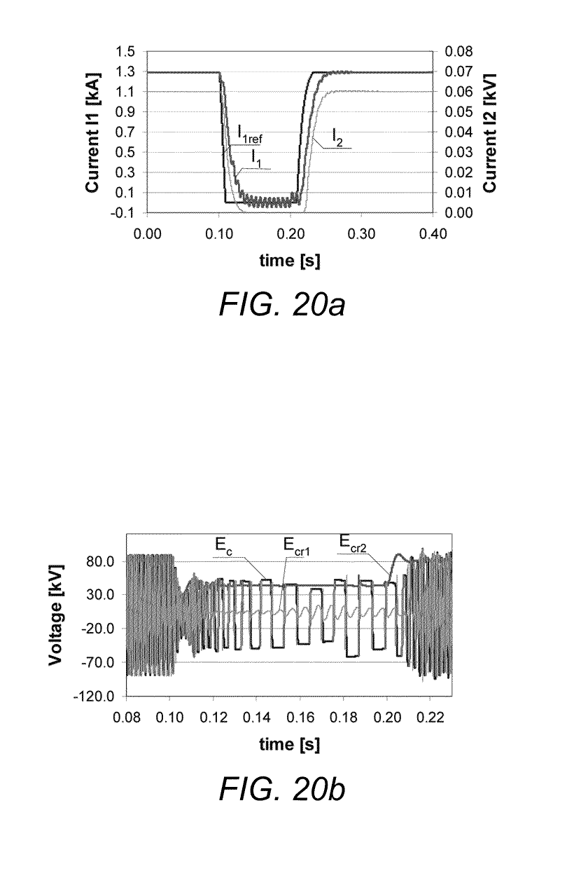

FIGS. 20a and 20b show the results of PSCAD simulations for fault interrupting tests performed using the converter of FIG. 13 with the fault interrupting control circuit of FIG. 17, for step-up operation and a 0.1 s fault on V₂, ie, fault A;

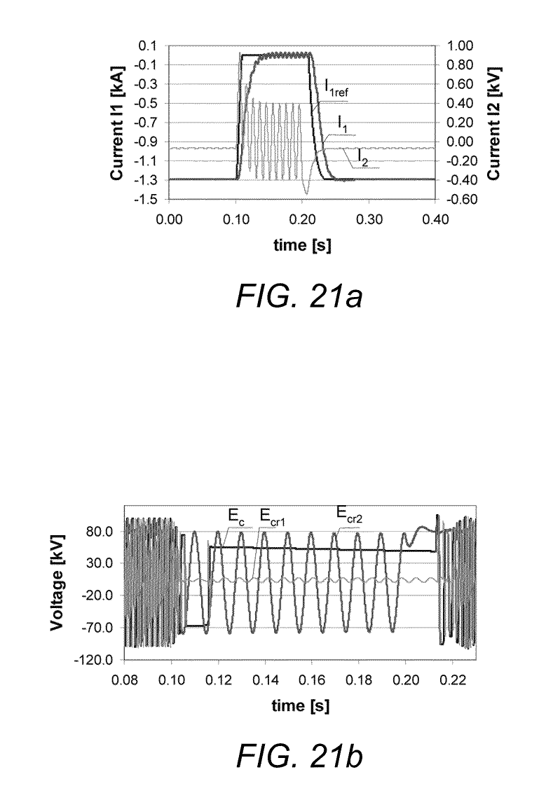

FIGS. 21a and 21b show the results of PSCAD simulations for fault interrupting tests performed using the converter of FIG. 13 with the fault interrupting control circuit of FIG. 17, for step-down operation and a 0.1 s fault on V₂, ie, fault D;

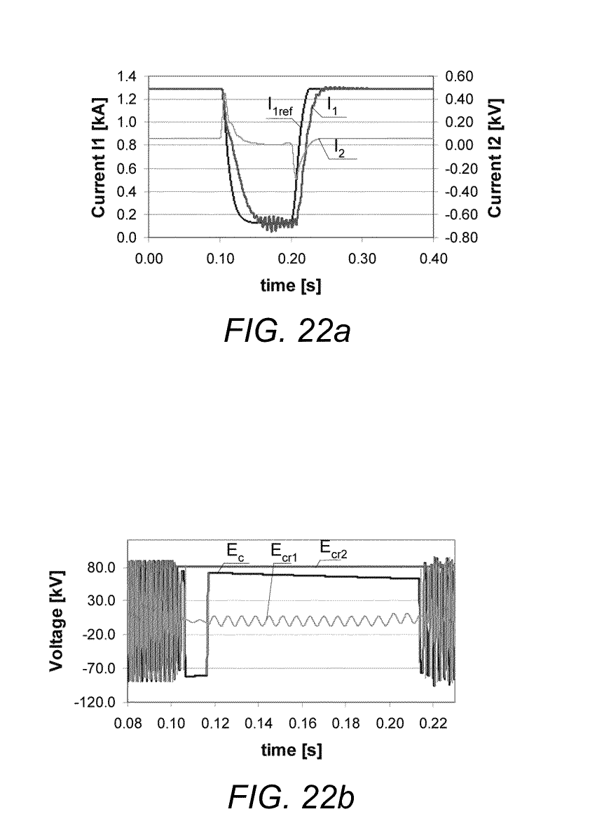

FIGS. 22a and 22b show the results of PSCAD simulations for fault interrupting tests performed using the converter of FIG. 13 with the fault interrupting control circuit of FIG. 17, for step-up operation and a high impedance 0.1 s fault on V₂, ie, fault C;

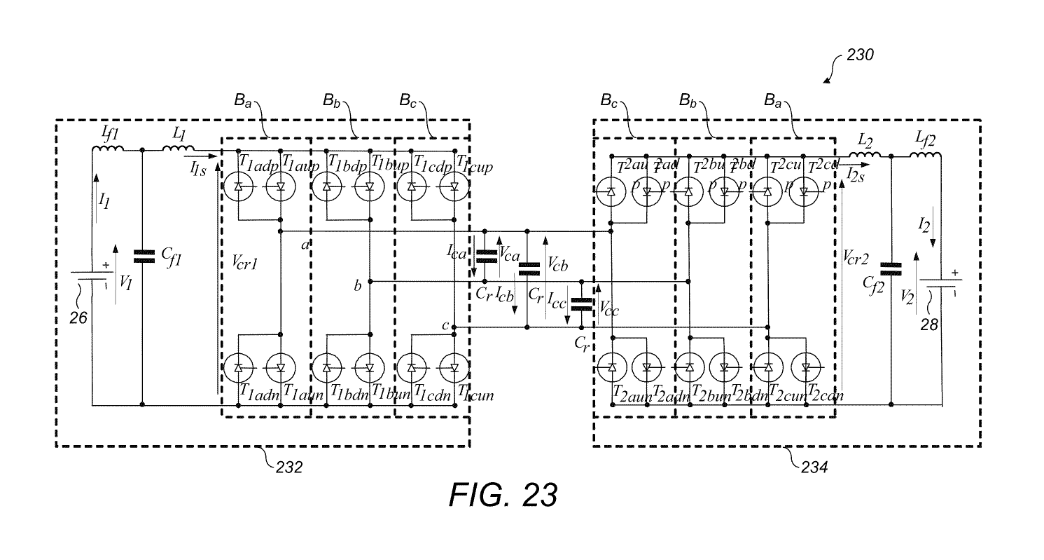

FIG. 23 shows the topology of 3-branch bidirectional converter, comprising three Delta connected capacitors Cᵣ, which embodies the present invention (V₁<V₂), wherein current polarity can be reversed at both the low and high voltage terminals;

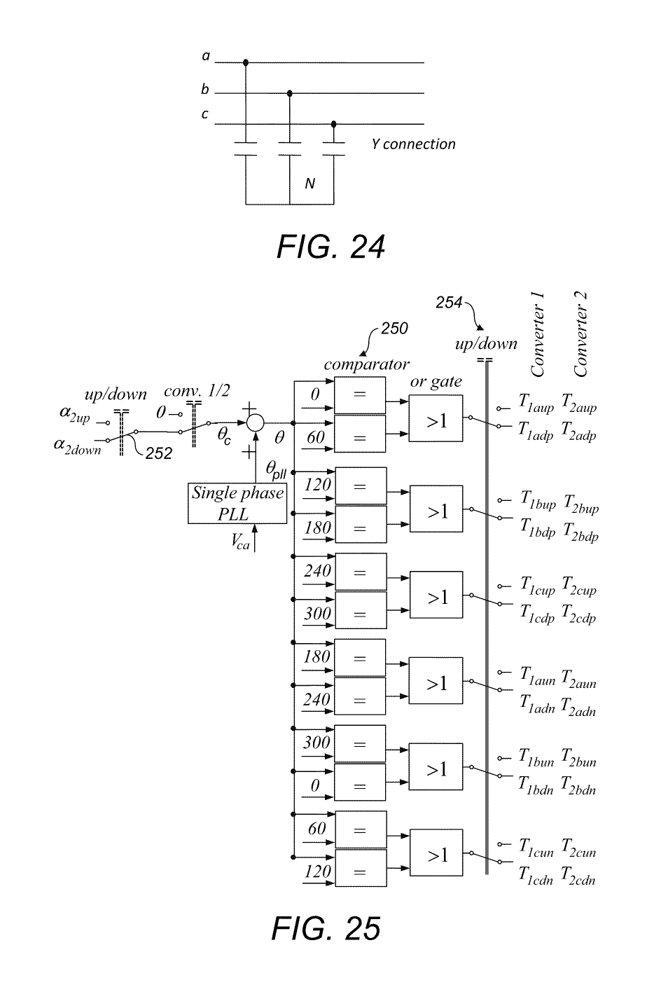

FIG. 24 shows an alternative arrangement (Y connection) of the capacitors Cᵣ for use in the circuit of FIG. 23;

FIG. 25 shows, in schematic form, the control system for step-up and step-down operation of the bidirectional converter of FIG. 23;

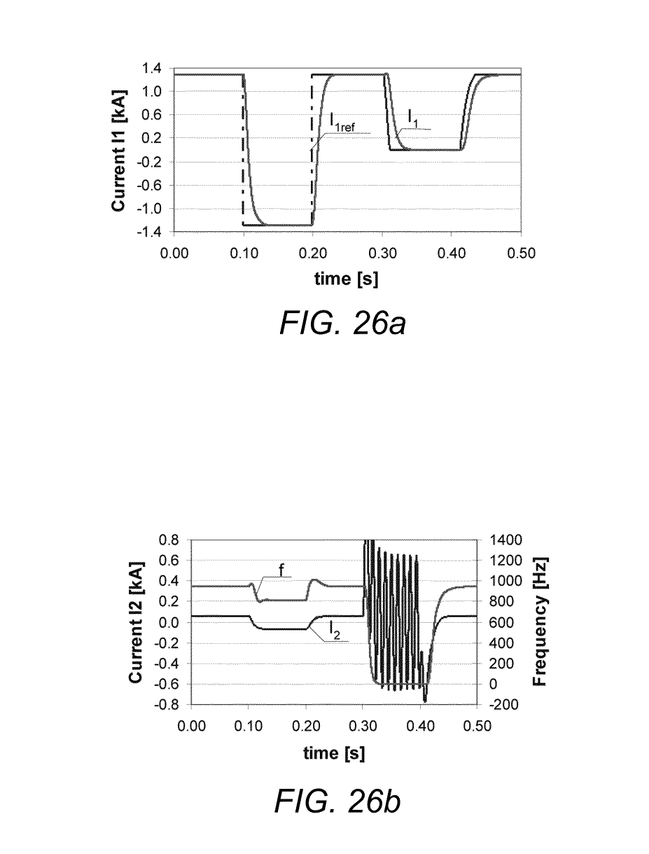

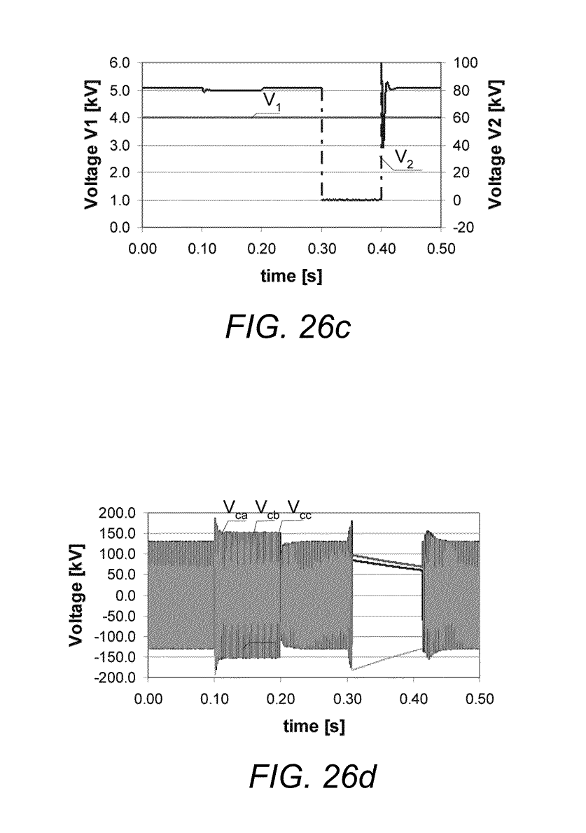

FIGS. 26a to 26d show the results of PSCAD simulations for fault interrupting tests performed using the converter of FIG. 23 (in Delta connection) with the fault interrupting control circuit of FIG. 17, with power reversal and a low impedance 0.1 s fault on V₂;

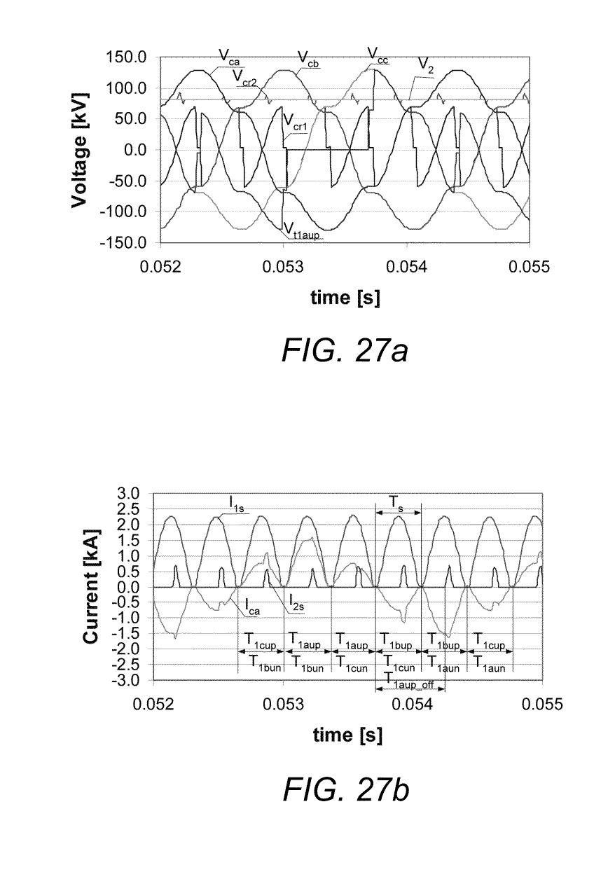

FIGS. 27a and 27b show detailed PSCAD simulation voltage and current traces for the 3-branch converter of FIG. 23 with the capacitors Cᵣ in Delta connection, operating in step-up mode;

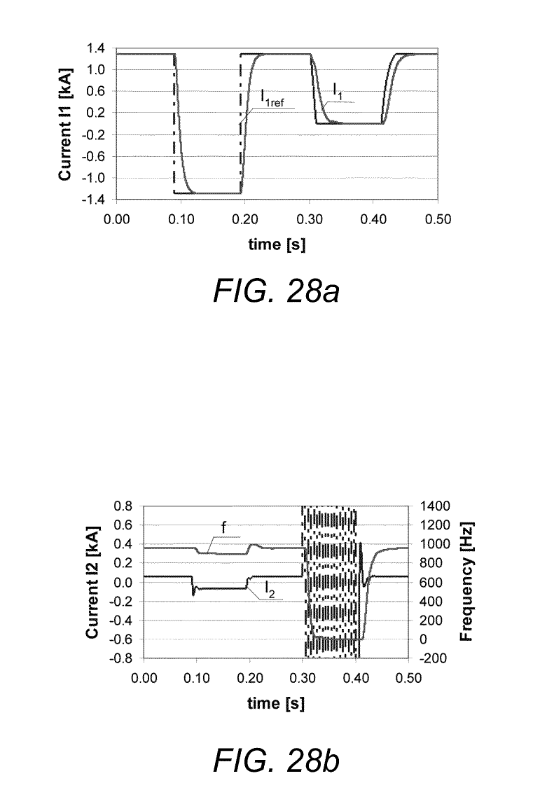

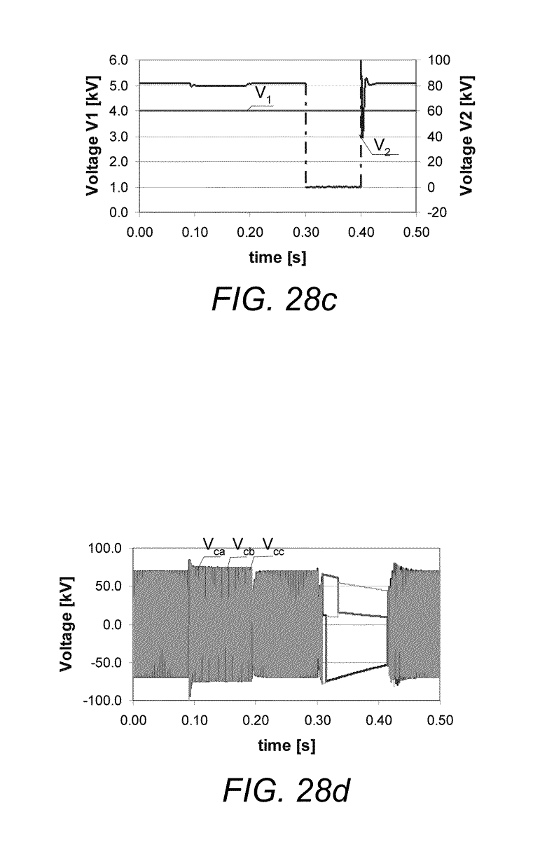

FIGS. 28a to 28d show the results of PSCAD simulations for fault interrupting tests performed using the converter of FIG. 23 (in Y connection) with the fault interrupting control circuit of FIG. 17, with power reversal and a low impedance 0.1 s fault on V₂;

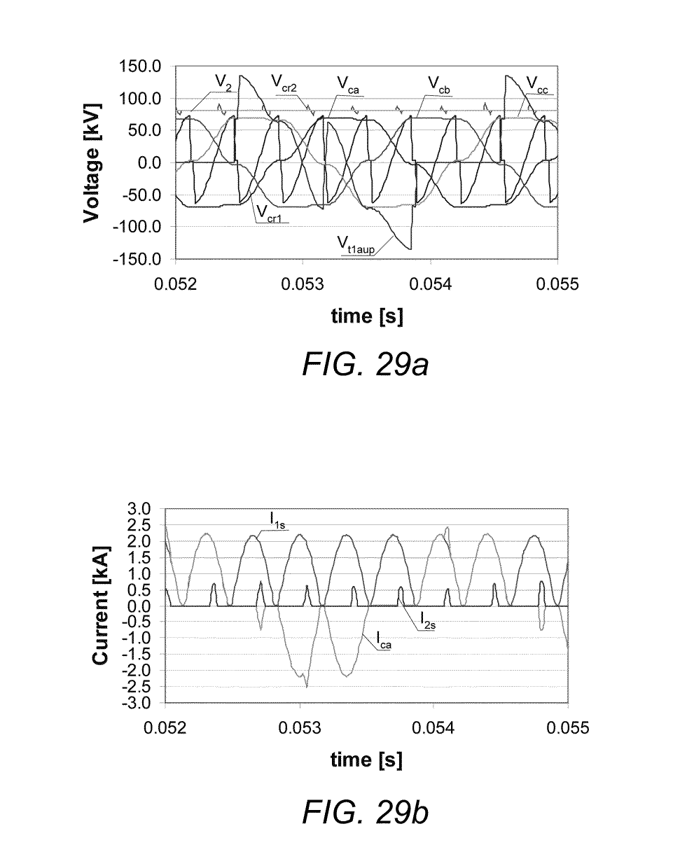

FIGS. 29a and 29b show detailed PSCAD simulation voltage and current traces for the 3-branch converter of FIG. 23 with the capacitors Cᵣ in Y connection as shown in FIG. 24, operating in step-up mode;

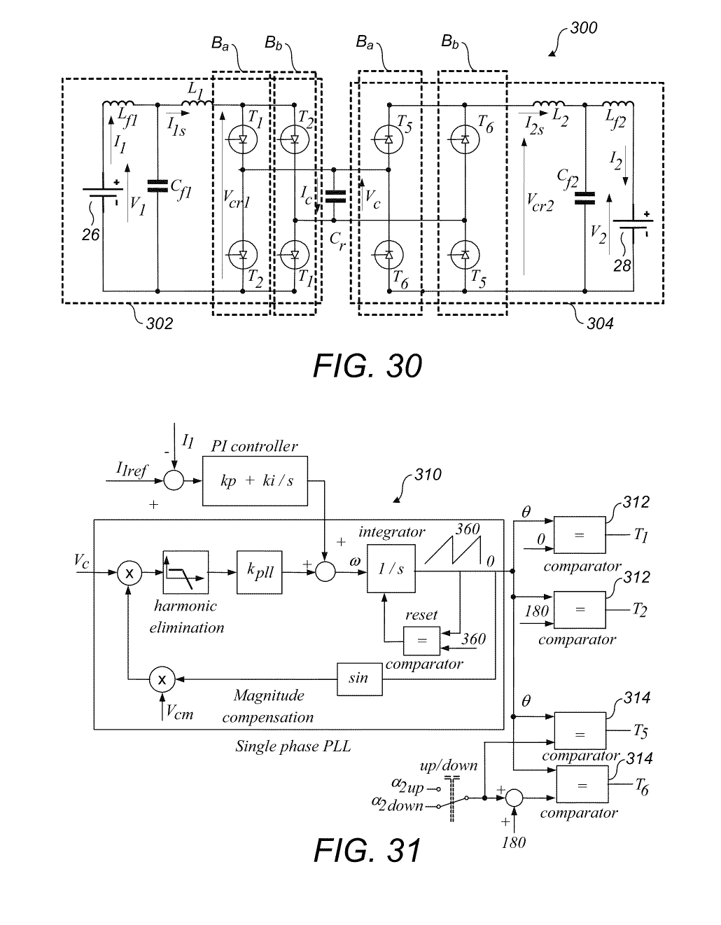

FIG. 30 shows the topology of a converter which embodies the present invention (V₁<V₂), wherein current polarity can not be reversed at either the low or high voltage terminals, although power reversal may be achieved by reversing the voltage polarity at both the low and high voltage terminals; and

FIG. 31 shows, in schematic form, the control system for converter of FIG. 30.

In the figures, components or elements common to more than one figure or embodiment have been identified with common reference symbols or numerals.

The present inventors have established that step-up power converters suitable for operation at MW power levels can be developed based on the principle of rotating the capacitor in a series LC circuit. By rotating the capacitor such that it changes polarity in the circuit, operation at a permanently positive voltage derivative and thus a permanent voltage increase can be obtained.

The underlying principles may be understood by analysis of the LC circuit 10 shown in FIG. 1a. LC circuit 10 comprises an inductor Lᵣ and a capacitor Cᵣ connected in series and driven by a voltage source V₁. The time domain response of the current I₁ and the capacitor voltage V_{cr} are given by:

I₁(t)=I₁₀ cos(ωₒ(t−t₀))+((V₁−V_{cr0})/z₀)sin(ωₒ(t−t₀)) (1)

V_{cr}(t)=V₁−(V₁−V_{cr0})cos(ωₒ(t−t₀))+z₀I₁₀ sin(ωₒ(t−t₀)) (2)

where t is time, t₀ is the initial time, I₁₀ is the initial value of I₁ (ie, at t=t₀), ω₀=2πf_{C}=1/√(LᵣCᵣ) is the natural frequency of the LC circuit, V₁ is the input terminal DC voltage, V_{cr0} is the initial value of V_{cr} in each cycle (at t=t₀), z₀=√/(Lᵣ/Cᵣ), Lᵣ is the inductance of the inductor Lᵣ, and Cᵣ is the capacitance of the capacitor Cᵣ.

Graphs of I₁(t) and V_{cr}(t) are shown in FIG. 1b.

To achieve a permanent voltage increase, the first derivative of the voltage with time, dV_{cr}/dt, must be permanently positive. From equation (2), the first derivative of the voltage V_{cr}(t) is given by:—

dV_{cr}/dt=ωₒ(V₁−V_{cr0})sin(ωₒ(t−t₀))+ωₒz₀I₀ cos(ωₒ(t−t₀)) (3)

From equation (3) it can be concluded that dV_{cr}/dt is positive where V_{cr0}<V₁ (condition 1) and where 0<ωₒt<π (condition 2).

The present inventors have established that condition 1 can be satisfied by using switches to “rotate” the capacitor Cᵣ, such that it changes polarity in the circuit when the capacitor voltage exceeds −V₁, and before it reaches its peak. By rotating the capacitor at an instant t₁, when the capacitor voltage is V_{cr}(t₁), the initial voltage in the next cycle becomes V_{cr0}=−V_{cr}(t₁). The first term in equation (3) thus becomes positive and the magnitude of the voltage is proportional to V₁−V_{cr0}.

Condition 2 requires that operation takes place in the positive current region identified as 12 in FIG. 1b, where the capacitor voltage V_{cr} increases. Under this condition, V_{cr} at the end of the cycle will be larger than the value at the end of the previous cycle.

The present inventors have used the above principles to develop practical step-up power converters that achieve permanently increasing DC voltage for a constant operating frequency (control input). At the end of each cycle, the voltage on the capacitor Cᵣ will be higher than in the previous cycle by a certain value. The voltage therefore increases with each switching step.

Such converters comprise an inductor L₁ (which corresponds to the inductor Lᵣ in the circuit of FIG. 1a) and a capacitor Cᵣ connected in series with the inductor Lᵣ across the low voltage terminals, a plurality of switches for switching the polarity of the capacitor Cᵣ in the circuit and a controller for controlling the switching to repeatedly change the polarity of the capacitor at a switching frequency fₛ, so as to produce a permanently increasing voltage V_{cr} at the high voltage side of the inductor L₁, (ie, positive dV_{cr}/dt), other than at the instant of switching.

The topology for one such converter 20 is illustrated in FIG. 2. The converter comprises low voltage terminals 26, which connect to a low voltage source V₁, and high voltage terminals 28 which connect to a high voltage load V₂. As with the LC circuit of FIG. 1a, the converter comprises a resonant inductor L₁ and a capacitor Cᵣ. However, in the converter of FIG. 2, the capacitor Cᵣ is incorporated into a bridge circuit comprising two pairs of thyristor switches T₁, T₂ connected in two branches Bₐ, B_{b}. Branch Bₐ comprises the first T₁ thyristor connected in series with the second T₁ thyristor, and branch B_{b} comprises the second T₁ thyristor connected in series with the first T₂ thyristor. Both branches are connected in series with the inductor L₁ across the low voltage terminals 26. All four thyristors T₁, T₂ are connected in the same orientation. The capacitor Cᵣ is connected between the two branches via nodes respectively located between the two thyristors which form each branch.

With this arrangement, the polarity of the capacitor Cᵣ in the circuit can be changed by firing the first pair of switches T₁, followed by the second pair T₂. The capacitor can thus be “rotated” in the circuit by alternately firing the first pair of switches together, and the second pair of switches together. In this way, the capacitor-inductor circuit always stays connected in series across the low voltage terminals 26. However, the polarity of the capacitor repeatedly reverses.

The commutation of capacitor current from one thyristor pair to the other is always assured. This means that the converter naturally extinguishes thyristor current. For example, by firing T₁, the current I₁ is transferred from T₂ to T₁, since T₁ provides lower cathode voltage and a lower resistance current path. This natural commutation means that the switches do not need turn-off capability, and thus allows for the use of thyristors, thereby making the converter suitable for use at MW range power levels. However, alternative switches may be used as appropriate for the specific application. For example, MOSFET, IGBT, GTO, etc (with series diode).

In the circuit of FIG. 2, switching is controlled by a control circuit, such as that shown in FIG. 7, which conveniently comprises a primary feedback PI regulator which controls the voltage at the high voltage terminals V₂, the current I₂ at the high voltage terminals, the current I₁ at the low voltage terminals, the power P, or some other variable, depending on the application. The controller also conveniently comprises a phase locked loop (PLL) which aids in synchronizing the firing of the thyristors T₁, T₂ with the capacitor voltage.

The two pairs of thyristors T₁, T₂ are fired at a constant phase angle, resulting in a 50% duty ratio (equal conduction interval for the T₁ pair as for the T₂ pair). Conveniently, T₁ are fired at 0 degrees and T₂ at 180 degrees. Typically, the switches are fired with ˜10 degree pulses for thyristor latching. The firing of the low voltage circuit thyristors (T₁ and T₂) is predominantly determined by the operating frequency fₛ. Controlling the frequency fₛ achieves the same effect as controlling the phase angle θ, but frequency control is one differential order faster (ω=dθ/dt).

In the high voltage circuit 24 of the converter 20, the capacitor Cᵣ is connected to the high voltage terminals 28 via two pairs of diodes D₅, D₆ and a second inductor L₂. The two pairs of diodes are arranged in a similar two-branch configuration to the thyristors T₁, T₂ on the low voltage side, each branch Bₐ, B_{b}. being connected in series with the inductor L₂ across the high voltage terminals 28. The capacitor Cᵣ is connected between the two branches via nodes respectively located between the two diodes which form each branch.

The diodes D₅, D₆ thus act to rectify the alternating voltage of the rotating capacitor Cᵣ, so as to enable a current I₂ to flow between the capacitor and the high voltage terminals 28 in the direction indicated in the figure.

The second inductor L₂ is not essential for operation. However, a small inductor will reduce the harmonics on the current I₂ at the high voltage terminals and reduce current derivatives in the diodes D₅, D₆.

In the circuit of FIG. 2, the voltage V_{cr1} at the high voltage side of the inductor L₁ (which corresponds to the voltage V_{cr} discussed above) has a sawtooth waveform (ie, constantly increasing, other than at the instant of switching), where the slope of the ramp is dependent on the natural frequency ωₒ of the circuit, the initial voltage V_{cr10} (assumed to be equal to the voltage V₂ at the high voltage terminals) and the initial current I₁₀. In unloaded operation, the sawtooth waveform will have voltage peaks of increasing magnitude. The V_{cr10} voltage increase over the previous cycle represents the energy transferred from the low voltage source V₁ to the switched capacitor Cᵣ.

Balanced operation of the converter is achieved when the power transfer through the converter matches the load power, and the output voltage remains constant.

Steady-state operation of the converter is achieved if the capacitor voltage V_{cr1} at the end of each cycle equals the initial voltage V_{cr10} (with the opposite sign), and the voltage V₂ at the high voltage terminals. Since the current I₁ at the low voltage terminals does not change polarity, in balanced operation, the current at the beginning of the cycle I₁₀ equals the current at the end of the cycle.

With reference to FIG. 3, the power transfer through the converter is achieved in a period B-C, during which the diodes D₅, D₆ conduct. Assuming that L₂ is small, and that the diode resistance is small, it can be concluded that V_{cr}≈V₂ and I₁≈I₂ (t_{B}<t<t_{C}). This condition allows all the variables in instants B and C to be calculated as follows:

I_{1B}=√(4V₁V₂)/zₒ, V_{crB}=V₂, cos(ωₒt_{B})=(V₁−V₂)/(V₁+V₂) (4)

V_{crC}=V_{crD}=−V_{crA}=V₂, I_{1C}=I_{1A}=I_{1D}=0 (5)

Using equations (4) and (5), the energy transfer through the converter is given by:

E_{BC}=∫_{tB}^{tC}V₂I₁dt=2V₁V₂²Cᵣ/(V₂−V₁) (6)

It can be seen that the energy transfer E_{BC} is influenced by the size of the capacitor Cᵣ. The average energy transfer over one switching interval (Tₛ=t_{D}−t_{A}) is:

E_{AVE}=I₂V₂Tₛ (7)

The current I₂ in equation (7) represents the average value over one cycle. Equating equations (6) and (7) gives the basic converter design equation:

I₂(V₂−V₁)/V₁V₂=2Cᵣfₛ {fₛ≧2fₒ} (8)

In the case of reasonable stepping ratios (V₁<V₂), and with minimal loss in accuracy, equation (8) simplifies to:

I₂/V₁=2Cᵣfₛ {fₛ≦2fₒ} (9)

The voltage stepping ratio is not a factor in equation (9), and it has minimal influence in equation (8). This means there is no theoretical limit on the voltage V₂ at the high voltage terminals and thus on the stepping ratio achievable by the converter. Accordingly, the stepping ratio is only relevant in selecting the component rating. It can also be concluded that the converter is designed on the basis of the current I₂ at the high voltage terminals. The converter loading can also theoretically be infinitely large, provided the capacitor Cᵣ and the switching frequency fₛ are sufficiently large. Equation (9) shows that converters of this type are fundamentally different from conventional boost converters because, with conventional boost converters, the voltage ratio is directly dependent on the control signal.

It is also very important to analyze converter operation in unloaded conditions. In unloaded conditions, it can be assumed that I₂=0. This implies that the capacitor voltage increases to a value that is higher than the value of voltage V₂, as can be seen in FIG. 3. Using equations (1) and (2), it can be shown that, for the unloaded converter, the capacitor voltage at the end of a cycle is:

V_{crC}=V₂+2V₁ (10)

Equation (10) is very important because it indicates that the voltage increase in one interval is always constant (ΔV_{cr}=2V₁), and thus independent of the LᵣCᵣ circuit parameters, the output voltage, loading, or the actual operating frequency. Taking voltage V₂ as the output and frequency as the input, equation (10) implies that an unloaded converter behaves as an integrator described by dV₂/dt=2V₁fₛ. Because of this integral relationship at a constant operating frequency, the converter is suitable for fast regulation of output voltage and for achieving high stepping ratios.

Operation in discontinuous mode yields low switching losses, because switching is done at zero current and a smaller inductor can be used. However, the I₁ ripple is larger than in continuous mode. To minimise the I₁ ripple under normal loading, the highest switching frequency possible in discontinuous mode can be employed, ie, the border with continuous mode, fₛ=2fₒ.

The average current I₁ₐᵥ at the low voltage terminals in discontinuous mode is obtained by averaging (1) with I₁₀=0:

$$\begin{matrix}{I}_{lav} = ( 1 / {t}_{1} ) {\int }_{0}^{t 2} ( {V}_{1} - {V}_{cr 10} / {Z}_{0} ) sin ( {ω}_{o} t ) d t & \\ = ( {V}_{1} + {V}_{2} ) 2 {f}_{s} / {ω}_{o} {Z}_{o} & \{ {f}_{s} \leq 2 {f}_{o} \}\end{matrix} \qquad ( 11 )$$

The peak value of I₁ is given by:

I₁ₚ=(V₁−V₂)/zₒ {fₛ≦2fₒ} (12)

If the current I₂ at the high voltage terminals is known, then the voltage V₂ can be obtained from the power balance equation I₁V₁=I₂V₂.

Continuous mode operation is achieved when the converter operates with a switching frequency of fₛ>2fₒ. In continuous mode, the initial current is greater than zero, ie, I₁₀>0. Using the assumption that V_{cr}≈V₂ and I₁≈I₂ (t₃<t<t_{C}), the variables in instants B and C can be calculated as follows:

I_{1B}=I_{1A} cos(ωₒt₃)+(V₁+V₂)/zₒ·sin(ωₒt_{B}) (13)

V_{crB}=V_{crC}=V₂=V₁−(V₁+V₂)cos(ωₒt_{B})+zₒI_{1A} sin(ωₒt_{B}) (14)

I_{1C}=I_{1A}=I_{1B}+(V₁−V₂)/Lᵣ(t_{C}−t_{B}) (15)

The energy transfer through the converter in interval B-C is:

E_{BC}=∫_{tB}^{tC}V₂I₁dt=(I₁²(t_{B})−I₁²(t_{A}))/2Lᵣ(V₂−V₁) (16)

By manipulating equations (13) and (14), it can be proven that:

I_{1B}²−I_{1A}²=4V₁V₂/zₒ² (17)

Replacing equation (17) in equation (16) gives the converter design equation in continuous mode:

I₂(V₂−V₁)/V₁V₂=2Cᵣfₛ {fₛ>2fₒ} (18)

It is evident that equation (18) is identical to equation (8), and thus that this is the general design equation for converters of this type, applicable in either continuous or discontinuous mode, ie for fₛ>2fₒ as well as for fₛ≦2fₒ.

Analysis of the unloaded converter operation in continuous mode gives the same equation for voltage increase as obtained for discontinuous mode, ie equation (10).

The peak current in continuous mode can be obtained from equation (11), and conditions (13) and (14).

I_{1P}=(V₁+V₂)/zₒ)√/(2/(1−cos(ωₒ/f)) {fₛ>2fₒ} (19)

In a practical system, the switching frequency can not be increased indefinitely, due to increased switching losses and limitations imposed by the material properties of switches and their snubber circuits. In particular, the capacitor voltage undergoes voltage change from V_{cr10} to =V_{cr10} (ie, 2V₂) in a single cycle. This imposes significant dV/dt on the switches as the frequency increases. Simulation tests with realistic switches and parasitic losses indicate that the current I₂ reaches a peak and saturates as the frequency increases. Under these conditions, equation (18) will not hold and the system will behave as if driving a frequency dependent internal load.

FIG. 4 shows typical curves for ΔV_{cr1} and the output power P₂ for a capacitor value of Cr=20 μF, an inductor value of Lᵣ=0.05H, an input voltage V₁=4 kV, and a load impedance R₂=1330Ω, with realistic parasitic losses. Operation with a constant voltage at the high voltage terminals, V₂=80 kV, is assumed.

FIG. 4 shows that I₂ and P₂ increase with switching frequency up to a threshold frequency, above which they drop to zero. It is therefore desirable to operate at or below this threshold frequency, ie, the frequency which gives maximum power. The value of the threshold operating frequency depends on the converter parameters, internal losses, and the stepping ratio, and therefore needs to be calculated for the specific application.

For a constant impedance load, the output current is I₂=−V_{cr0}/R₂, where R₂ is the load impedance. Replacing this requirement in equation (8) for discontinuous mode and equation (18) for continuous mode gives the theoretical current and voltage curves shown in FIGS. 5a and 5b.

FIGS. 5a and 5b show that, with a constant impedance load, the output voltage V₂ is linearly proportional to the switching frequency fₛ. The current I₁ is a piecewise linear function, with higher gain in continuous mode than in discontinuous mode. The output power P₂ will therefore be a parabolic function of the operating frequency. From FIGS. 5a and 5b and equation (18) it can be concluded that the converter should be controlled by varying the switching frequency fₛ.

If the system is required to operate in both continuous and discontinuous mode, the controller should have some form of gain scheduling to compensate for gain change at the transition between modes. Because of the linear control characteristic, the control method for the above converter in both modes is very simple. This is a significant improvement over conventional boost converters, which are difficult to control because they have highly non-linear and voltage-dependent controller gain, particularly in the high boost region [1].

In summary, the following steps can be followed in designing a unidirectional step-up converter suitable for a specific application.

Assuming that the power transfer is given, and considering the nature of the switches, the desired operating frequency fₛ can be determined.

Assuming V₁, V₂, the power transfer P₂ and the frequency fₛ are given, the initial working value for the capacitance Cᵣ can be determined from equation (9), ie, Cᵣ=I₂/(2fₛV₁).

If discontinuous mode is required, then the value of the inductor L₁ is calculated (from fₛ<2fₒ) as L₁≦1/(π²f²Cᵣ). Thus, at the border, or limit, of discontinuous mode,

L₁=1/(π²f²Cᵣ) (20)

If continuous mode is required, then the value for the inductor L₁ should be calculated to minimise input current ripple using equation (19).

When selecting a suitable inductor L₁, in addition to the greater size and cost of larger inductors, too large a value of L₁ may create operating problems. Accordingly, fₛ/fₒ should be limited according to practical limitations.

Practical simulations with realistic dV/dt limitations and switching losses can be used to determine final parameter selection.

Unidirectional converters of the type discussed above can achieve very high step-up ratios, and are operational at MW power levels.

In certain circumstances, a bidirectional converter is desirable. That is to say, a converter in which the direction of power transfer is reversible to allow for both step-up operation in which power is transferred from the low voltage terminals to the high voltage terminals, and step-down operation in which power is transferred from the high voltage terminals to the low voltage terminals. Such a converter would be useful, for example, as an interface between a DC storage system and a DC network.

In order to reverse the direction of power transfer through a converter, it is necessary to change either the current direction or voltage polarity at both the high and low voltage terminals. This may be achieved externally of the converter, by changing the voltage polarity at both terminals. Voltage polarity change is required when connecting to constant current DC systems, such as large machine drives which use thyristor based AC-DC converters. However, where the voltage polarity at the terminals in question is fixed, the current direction must be changed in order to reverse the direction of power transfer.

FIG. 6 shows the topology for a bidirectional power converter 60 which embodies the present invention. The converter of FIG. 6 can change the direction of power transfer by changing voltage polarity at the low voltage terminals and by changing current direction at the high voltage terminals.

The low voltage circuit 62 of the circuit 60 resembles the low voltage circuit 22 of the converter of FIG. 2. In this respect, the low voltage circuit 62 comprises low voltage terminals 26, a resonant inductor L₁ and two pairs of thyristor switches T₁ and T₂ arranged in two branches Bₐ and B_{b}, as described above in relation to FIG. 2. Each thyristor T₁, T₂ constitutes a unidirectional switch. As with the circuit of FIG. 2, a capacitor Cᵣ is connected between nodes respectively located between the two thyristors of each branch, which are referred to as central branch terminals.

The high voltage circuit 64 of the circuit 60 resembles the high voltage circuit 24 of the converter of FIG. 2, except that the two pairs of diodes D₅ and D₆ are replaced by four pairs of thyristor switches T₅, T₆, T₇ and T₈. In this respect, the high voltage circuit 64 comprises high voltage terminals 28 and a second inductor L₂, and the thyristor switches T₅, T₆, T₇ and T₈ are arranged in two branches Bₐ, B_{b}.

The first thyristor branch Bₐ comprises the first T₅ thyristor connected in series with the second T₆ thyristor, and the first T₇ thyristor connected in series with the second T₈ thyristor, the two pairs of series connected thyristors being connected together in antiparallel.

Similarly, the second branch B_{b} comprises the first T₆ thyristor connected in series with the second T₅ thyristor, and the first T₈ thyristor connected in series with the second T₇ thyristor, the two pairs of series connected thyristors being connected together in antiparallel. Thus, each thyristor T₅ is connected in antiparallel with a T₇ thyristor to constitute a bidirectional switch T₅/T₇. Similarly, each T₆ thyristor is connected in antiparallel with a T₈ thyristor to constitute a bidirectional switch T₆/T₈.

The capacitor Cᵣ is connected between the two branches via nodes respectively located between the series connected thyristors in each branch, ie, between central terminals of branches.

That is to say, each branch in each circuit has two DC terminals, and one AC terminal. The branch is connected across the respective voltage terminals by the two DC terminals. The capacitor Cᵣ is connected to the AC terminal of each branch, ie, the central terminal between the two thyristor switches of each branch. This connection allows alternating capacitor current.

An LC filter comprising a filter inductor L_{f1} and a filter capacitor C_{f1} is connected across the low voltage terminals 26, and a similar LC filter comprising a filter inductor L_{f2} and a filter capacitor C_{f2} is connected across the high voltage terminals 28. These LC filters are not essential to the operation of the converter. If present, their parameters will depend on the harmonic level requirements on the connecting grids.

Except for the filter components L_{f1}, C_{f1}, the low voltage circuit 62 is identical to the low voltage circuit 22 of the unidirectional converter of FIG. 2, and operates in precisely the same manner to switch the polarity of the capacitor Cᵣ.

In the high voltage circuit 64, for operation in step-up mode, ie to transfer power from the low voltage terminals 26 to the high voltage terminals 28, switches T₇ and T₈ are off (not actuated), whilst T₅ and T₆ are permanently fired, or gated. In this state, the switches are effectively equivalent to the diodes D₅ and D₆ in the high voltage circuit 24 of FIG. 2, and the converter operates in precisely the same manner as the unidirectional converter 20.

For operation in step-down mode, the direction of power transfer is reversed, such that power is transferred from the high voltage terminals 28 to the low voltage terminals 26. To achieve this, the current direction through the high voltage terminals 28 (ie, the direction/polarity of I₂) and the voltage polarity at the low voltage terminals 26 (ie, the polarity of V₁) are reversed, whilst the current direction through the low voltage terminals 26 (I₁) and the voltage polarity at the high voltage terminals 28 (V₂) remain unchanged.

Table 1 compares the polarity of variables for step-up and step-down operation.

TABLE 1

| Power direction (Mode) | P | V₁ | I₁ | V₂ | I₂ |
|---|---|---|---|---|---|
| V₁ to V₂ (step-up) | + | + | + | + | + |
| V₂ to V₁ (step-down) | − | − | + | + | − |

Since the low voltage circuit 62 carries the higher current, ie, I₁>I₂, the low voltage circuit determines the operating frequency fₛ.

The design of the converter therefore follows the method presented above for the unidirectional converter, and values for the low voltage circuit parameters (L₁) and the value of the rotating capacitor Cᵣ are thus selected as described above in relation to the unidirectional version of the converter.

The high voltage circuit 64 also operates as an LC series resonant circuit with a rotating capacitor in a similar manner to the low voltage circuit 62. However, the current in the high voltage circuit will be lower and the resonant frequency higher than in the low voltage circuit. Therefore, the high voltage circuit is typically operated in discontinuous mode with short conduction intervals.

Thus, the thyristors switches T₅, T₆, T₇, T₈ in the high voltage circuit 64 carry a lower current and have shorter conduction intervals, meaning that there is freedom in choosing the firing angle (the instant of firing on an ω₀ cycle).

FIG. 7 shows a control system 70 for controlling the operation of the circuit 60 of FIG. 6, by controlling the firing of the thyristor switches. The control system 70 is based on the frequency regulation principle where the firing frequency is obtained from the control system. The frequency may be synchronised with the capacitor voltage V_{c} using a Phase Locked Loop (PLL) to improve stability, although this is not essential. A single-phase PLL is required with magnitude compensation, such as that described in reference [12].

In the description below, discontinuous operation is assumed, since operation in discontinuous mode reduces switching losses, which is very important at high power levels.

The thyristor switches T₁, T₂ in the low voltage circuit 62, are always operated with minimal zero-current intervals, ie, they are fired at 0 and 180 degrees, as is the case with the unidirectional converter of FIG. 2. The thyristors are fired typically with ˜10 degree repeating pulses for thyristor latching. This applies in both step-up and step-down mode.

In step-up mode, switches 72, 74 and 76 are connected to the T₅, T₆, and α₂ᵤₚ terminals respectively. In this state, the thyristor switches T₅ and T₆ are permanently fired, such that they effectively operate as diodes. Accordingly, in step-up mode, the converter acts as the unidirectional converter of FIG. 2.

In step-down mode, the switches 72, 74 and 76 are connected to the T₇, T₈ and α_{2down} terminals respectively. In this state, the thyristor switches T₇ are fired at a firing angle α_{2down} on the rising slope of the voltage across the capacitor V_{c}, and the thyristor switches T₈ are fired at a corresponding angle during the following half-cycle, ie, α_{2down}+180 degrees. This principle achieves the same polarity for I₂ in both half cycles.

FIGS. 8a and 8b show typical voltage and current waveforms for the converter of FIG. 6 operating in step-down mode. Point A on the voltage waveform V_{c} represents the start of the first half cycle (0 degrees). The thyristors T₇ are fired at a firing angle α_{B}=α_{2down}, during the first half cycle (0-180 degrees) which is represented by point B on the rising slope of the voltage V_{c} waveform. The switches T₇ conduct for a time interval T₇ that ends at point C. The inductor L₂ creates a resonant circuit with Cᵣ and the current I₂ naturally goes to zero at point C. In this way, the thyristor T₇ naturally turns off. Point D represents the V_{c} voltage peak at the end of the first half cycle (180 degrees), which is somewhat higher than the constant voltage V₂. During the second half cycle (180-360 degrees) V_{c} drops below V₂ at a point E, at which time T₇ become forward biassed. The time from C to E thus represents the extinction time T_{c7} for the switches T₇.

Firing the thyristors T₇ too early, ie at low V_{c}, will create a large potential across the inductor L₂, which will result in an increase in the peak value of V. On the other hand, firing the thyristors T₇ too late will reduce the extinction time Tₑ₇, which must be larger than the maximum turn-off period T_{off} for the type of thyristor used.

Too small an inductor L₂ will result in large current derivatives and current I₂ peaks on the high voltage side of the converter. The current derivatives must not exceed the maximum allowed values for the type of thyristor used, whilst high peak currents result in high harmonics. On the other hand, too large an inductor will result in large peak voltages on V_{c} and long conduction intervals T₇, and thus a reduced extinction time Tₑ, for the thyristors T₇.

Thus, in addition to the design parameters (Cᵣ, Lᵣ and fₛ) described above in relation to the unidirectional converter, which also apply here, the firing angle α_{2down} and the size of the inductor L₂ constitute two further design parameters of the converter. The optimum parameters may be determined in accordance with the above considerations using trial and error on digital simulators, or using a suitable analytical model with reference to FIGS. 6, 8a and 8b.

In the interval A-B in FIG. 8a, only the low voltage circuit 62 of the converter is in operation. There are thus two equations which define the operation of the circuit. At the end of the interval A-B, assuming I_{1A}=0, the voltage and current are given by:

V_{cB}=−V₁−(−V₁−V_{cA})cos(α_{B}) (21)

and

I_{1B}=(−V₁−V_{cA})/Z·sin(α_{B}) (22)

In the interval B-C both sides of the converter are in operation and three dynamic equations apply. The initial values for this interval are given by equations (21) and (22). At the end of the interval B-C:

$$\begin{matrix}{V}_{cC} = {L}_{1} {V}_{2} / ( {L}_{1} + {L}_{2} ) + ( {V}_{cB} + ( {L}_{2} {V}_{1} - {L}_{1} {V}_{2} ) / ( {L}_{1} + {L}_{2} ) ) cos ( {α}_{eC} ) + {L}_{2} {I}_{1 B} / ( {L}_{1} + {L}_{2} ) {Z}_{e} sin ( {α}_{eC} ) & ( 23 ) \\ {I}_{1 C} = {L}_{1} {I}_{1 B} / ( {L}_{1} + {L}_{2} ) + {L}_{2} {I}_{1 B} / ( {L}_{1} + {L}_{2} ) {Z}_{e} cos ( {α}_{eC} ) - ( {V}_{1} + {V}_{2} ) / ( {L}_{1} + {L}_{2} ) \cdot {α}_{eC} / {ω}_{e} - ( ( {L}_{2} {V}_{1} - {L}_{1} {V}_{2} ) / ( {L}_{1} + {L}_{2} ) - {V}_{cB} ) {L}_{2} / {L}_{1} {Z}_{e} \cdot sin ( {α}_{eC} ) & ( 24 )\end{matrix}$$

and:

$$0 = ( {V}_{1} + {V}_{2} ) / ( {L}_{1} + {L}_{2} ) \cdot {α}_{eC} / {ω}_{e} + ( - {L}_{2} ( {V}_{2} + {V}_{2} ) / ( {L}_{1} + {L}_{2} ) + {V}_{2} - {V}_{cB} ) sin ( {α}_{eC} ) / {Z}_{e} - {L}_{1} {I}_{1 B} / ( {L}_{1} + {L}_{2} ) + {L}_{2} {I}_{1 B} / ( {L}_{1} + {L}_{2} ) cos ( {α}_{eC} ) \qquad ( 25 )$$

In the interval C-D, only the low voltage side of the converter is in operation. At the end of the interval C-D:

−V_{cA}=−V₁−(−V₁−V_{cC})cos(α_{D})+Z₁I_{1C} sin(α_{D}) (26)

and:

0=I_{1C} cos(α_{D})+(−V₁−V_{cC})/Z₁ sin(α_{D}) (27)

where V_{cA}=−V_{cD}.

The low voltage circuit constants are:

Z₁=√(L₁/Cᵣ) (28)

ω₁=√(1/L₁C₁) (29)

and:

αₓ=ω₁tₓ (30)

The constants for the joint circuit (in the B-C interval) are:

Zₑ=√(L₂(L₁+L₂)/L₁Cᵣ) (31)

ωₑ=√((L₁+L₂)/L₁L₂C₁) (32)

αₑₓ=ωₑtₓ=αₓωₑ/ω₁ (33)

In equations (21) to (27), the following 8 variables are unknown V_{cA}, V_{cB}, I_{1B}, α_{B}, I_{1C}, V_{cC}, α_{eC} and α_{D}. For a given firing angle α_{D} (and a given value for L₂), the remaining 7 variables can be determined. To this end, numerical iterative methods using standard software such as MATLAB are preferred, as the equations are highly non-linear making explicit solution complex.

In a practical converter, the following constraint applies to the turn off times for thyristors T₇ and T₈:

(α_{E}−α_{C})/(ω₁>T_{off} (34)

where T_{off} is the maximum turn off time specified in the manufacturer's specification for the thyristors T₇ and T₈. A value of T_{off}=400 μS is considered as representative of the maximum turn off time for highest power thyristors (4 kV voltage), and this value is considered in the test systems described below.

FIG. 9 shows the selection of L₂ for the test system data specified in table 2 below. In FIG. 9, the value for α_{B} is calculated considering equation (32) and for different sizes of inductor L₂. If L₂=0.3 mH is selected, the maximum firing angle is α_{B}=127 degrees, the expected peak V_{c} voltage is V_{cpeak}=114 kV, and the calculated high voltage current derivative is dI₂/dtₘₐₓ=60 A/μs. The operating limit specified by the manufacturers for the switches considered in the test system is 100 A/μs.

In practice, some operating margin is required, and simulation shows that the angle α_{B}=α_{2down}=120 degrees is appropriate. Also, the peak voltage will be lower in a practical system which is operated in feedback control.

In a practical system, as the voltage increases, the power transfer increases, and the operating frequency is automatically lowered to achieve the reference power transfer. At lower operating frequency, the zero-current intervals increase and the peak voltage will reduce.

Since the capacitor voltage is always higher than V₂, the converter can operate in the case where V₂=V₁. Therefore, the converter can connect two DC sources of equal voltage, since the capacitor voltage will always be larger than the DC voltage at the terminals.

A bidirectional converter which embodies the present invention has been simulated as described below. The test system simulates a 5 MW converter for connecting a 4 kV DC voltage to an 80 kV transmission grid. The values for the main converter parameters are determined in accordance with the principles outlined above and are specified in table 2 below. A detailed model is developed on the professional power electronics simulator PSCAD/EMTDC [12].

Standard, 4.4 kV line-commutation thyristors with 400 μs turn off time are used in the test system in order to demonstrate the possible application of the circuit at higher power levels. However, fast turn off thyristors, with a turn off time of 100 μs, are available with lower ratings of up to 2.8 kV, and would also be suitable for the 5 MW converter studied in the test system. Such thyristors would enable higher switching frequency and smaller passive components.

A detailed PSCAD model of the switches T₁ to T₈ is used. Values for the various switch parameters used in this model are given in table 3 below. This data is based on the manufacturer's specification for Silicon Power C784 thyristors.

The theoretical operating frequency with these thyristors is fₛₘₐₓ=1/(2T_{off})=1250 Hz. Accordingly, to allow some margin, an operating frequency of fₛ=1000 Hz is selected.

For the purpose of the simulation, operation in discontinuous mode is selected. This means that all thyristor switchings are at zero current. Accordingly, losses do not increase with switching frequency. Some reverse recovery currents will be present, but they will not cause significant losses since the voltage across the thyristors is only (V₂−V₁)/V₂ during reverse recovery.

The mass of the low-voltage inductor L₁, and the impact of this inductor on losses in the circuit are very important. The theoretically calculated properties of inductors L₁ and L₂ are given in table 4 and illustrated FIG. 10. These properties indicate that a practical inductor is feasible.

Since the capacitor Cᵣ is the main energy storage component, the inductors L₁, L₂ are considerably smaller than those needed for a comparable, conventional step-up converter. Moreover, the inductor L₁ is several times smaller than a comparable (5 MW, 50 Hz, 80 kV/4 kV) AC transformer. In this respect, the mass is lower because the converter of the present invention operates at high frequency (1 kHz) and the inductor L₁ has only one winding.

The filters are designed to allow only 5% current ripple (on I₁ and I₂). Values for the filter components are given in table 2. In general, their size will depend on the specific application.

TABLE 2
Test System Parameters

| Parameter | Value | | Resistance |
|---|---|---|---|
| V₁ | 4 | kV | / |
| V₂ | 80 | kV | / |
| P₂ | 5 | MW | / |
| fₛ | 1000 | Hz | / |
| Cᵣ | 7.9 | μF | R_{cr} = 1 MΩ |
| L₁ | 12 | mH | R_{L1} = 15 mΩ |
| L₂ | 0.3 | mH | R_{L2} = 4.6 mΩ |
| α_{B} | 112° | | / |
| L_{f1} | 3 | mH | R_{Lf1} = 8 mΩ |
| C_{f1} | 250 | μF | R_{Cf1} = 1 MΩ |
| L_{f2} | 20 | mH | R_{Lf2} = 20 mΩ |
| C_{f2} | 50 | μF | R_{Cf2} = 1 MΩ |

TABLE 3
Switch Data for Thyristor Switches

| | |
|---|---|
| On resistance [mΩ] | 27 × 0.5 = 13 |
| Off resistance [MΩ] | 27 × 0.015 = 0.4 |
| Voltage drop [V] | 27 × 0.5 = 14.5 |
| Extinction time [μs] | 400 |

TABLE 4
Inductor Data - See FIG. 10

| | |
|---|---|
| L1 | L2 |

Core

| | |
|---|---|
| Material | laminated steel |
| Relative permeability | 4000 |
| Maximum flux density | 1.5 T |

Coil

| | |
|---|---|
| Wire | 4 × AWG4/0 |
| Fullness factor | 0.6 |

| | | |
|---|---|---|
| Inductance L [mH] | 12 | 0.3 |
| C Core size, length P [m] | 0.73 | 0.47 |
| C Core size width E [m] | 0.31 | 0.22 |
| Air gap 2 × G [m] | 2 × 0.3 | 2 × 0.07 |
| Number of turns | 4 × 240 | 4 × 83 |
| Peak current [A] | 2060 | 2060 |
| Steel mass [kg] | 1697 | 681 |
| Copper mass [kg] | 1488 | 439 |
| Total resistance [mQ] | 15.6 | 4.6 |

FIGS. 11a to 11c show the responses of the simulated converter operated in current control mode. It can be seen that the converter follows the current reference very well (at 0.2 s and 0.3 s), that the converter shows good robustness to substantial V₁ and V₂ voltage disturbance (at 0.6 s, 0.7 s. 0.8 s and 0.9 s), and that rapid change in power direction is achieved (at 0.4 s and 0.5 s), by changing the polarity of voltage V₁ and current I₂.

FIGS. 12a and 12b show detailed traces for voltage and current for step-down operation of the converter. The traces are in good agreement with the theoretical results illustrated in FIGS. 8a and 8b. The peak capacitor voltage V_{cpeak}≈100 kV is somewhat lower than the value predicted in FIG. 8b. This difference results from feedback control which reduces frequency in step-down mode due to increased voltage V_{c}, losses which are not considered in the analytical modelling, and the regulation on the high voltage line, which changes sign as the direction of power transfer reverses.

From FIGS. 12a and 12b, and based on further simulation testing with different converter ratings, it can be concluded that the capacitor voltage will have peak values V_{cpeak} of 20-30% higher than the voltage on the high voltage terminals V₂.

Switch stresses in the simulated converter are summarised in table 5. It can be seen that all values are well below the maximum limits specified by the manufacturer.

TABLE 5
Measured Switch Stresses

| | T₁, T₂ | | Maximum values for C784 |
|---|---|---|---|
| | (T₃, T₄) | T₅-T₈ | thyristors (Silicon Power) |
| Vₚₑₐₖ [kV] | 96 | 87 | 27 × 4.4 = 119 |
| Iᵣₘₛ [kA] | 1.25 | 0.06 | 1.65 |
| dV/dt [V/μs] | 8.1 | 4.4 | 1000 |
| dI/dt [A/μs] | 60 | 20 | 100 |
| Extinction | 500 | 480 | Typical 250, Maximum 400 |
| time [μs] | | | |

It will be appreciated that the purpose of the bidirectional switches T₅/T₇ and T₆/T₈ in the high voltage circuit 64 of the converter 60 of FIG. 6 is to allow the current direction in the high voltage circuit to be changed.

The converter of FIG. 6 enables the direction of power transfer to be reversed by changing the direction of the current I₂ in the high voltage circuit 64, and changing the polarity of the voltage V₁ at the low voltage terminals 26.

However, if it were required to change the voltage polarity on the high voltage terminals and the current polarity on the low voltage terminals, then the converter would require bidirectional switches T₁/T₃, T₂/T₄ in the low voltage circuit, and unidirectional switches in the high voltage circuit T₅, T₆. That is to say, additional thyristors T₃ and T₄ connected in antiparallel with the respective T₁ and T₂ thyristors would be required in the low voltage circuit, whilst the thyristors T₇ and T₈ would not be required.

In this case, the control circuit 70 of FIG. 7 would require additional switches (such as switches 142 and 144 of FIG. 14) for switching between T₁ and T₃, and between T₂ and T₄, to select step-up or step-down operation. The switches 72 and 74 of the control circuit 70 would not be required. Instead, the output terminals of the respective comparators would be permanently connected to the T₅, T₆ terminals.

In another case, it may be possible to change the voltage polarity at both the low and high voltage terminals. In this case, bidirectional switches may not be required in either the low or high voltage circuits. In this case, the switches T3, T4, T7 and T8 would not be required in the converter, such that both the low and high voltage circuits comprise only unidirectional switches T1, T2 and T5, T6 respectively. In this case, the switches 72 and 74 of the control circuit 70 of FIG. 7 would not be required, and the output terminals of the four comparators would be permanently connected to the respective T₁, T₂ and T₅, T₆ terminals.

Other than the aforementioned differences, the description and analysis of the converter of FIG. 6 applies equally to these alternative embodiments. In particular, the selection of the firing angles in the low and high voltage circuits to achieve step-up and step-down modes applies to these embodiments. That is to say, in the low voltage circuit either T₁ and T₂, or T₃ and T₄, are fired at 0 and 180 degrees. In the high voltage circuit, T₅ and T₆ are fired at α₂ᵤₚ (and α₂ᵤₚ+180 degrees) for step-up operation and α2down (and α2down+180 degrees) for step-down operation.

In applications where both the high and low voltage terminals are at fixed voltages, ie, V₁ and V₂ can not change, power reversal requires current polarity to change on both sides of the converter. To enable such operation, bidirectional switches (ie, two anti-parallel thyristors) are required in the low voltage circuit as well as the high voltage circuit. Table 6 shows the polarity of variables for step-up and step-down operation under these circumstances.

TABLE 6

| Power direction (Mode) | P | V₁ | I₁ | V₂ | I₂ |
|---|---|---|---|---|---|
| V₁ to V₂ (step-up) | + | + | + | + | + |
| V₂ to V₁ (step-down) | − | + | − | + | − |

FIG. 13 shows the topology for a bidirectional converter 130 that achieves power reversal through a current polarity change in both the low and high voltage circuits.

The low voltage circuit 132 is similar to the low voltage circuit 62 of the converter of FIG. 6, except that two further pairs of thyristor switches T₃ and T₄ are connected to the rotating capacitor Cᵣ.

In this respect, the T₃ and T₄ thyristors are connected in antiparallel with the corresponding T₁ and T₂ thyristors, such that the first T₃ thyristor is connected in series with the second T₄ thyristor in the first branch Bₐ, and the first T₄ thyristor is connected in series with the second T₃ thyristor in the second branch B_{b}.

The high voltage circuit 134 is identical to the high voltage circuit 64 of the converter of FIG. 6.

FIG. 14 shows a control system 140 for controlling the operation of the circuit 130 of FIG. 13, by controlling the firing of the thyristor switches. The control circuit is identical to the control circuit 70 of FIG. 7, except that two further switches 142, 144 are provided for switching between thyristors T₁ and T₂ (fired in step-up mode) and thyristors T₃ and T₄ (fired in step-down mode). Thus, in step-up mode, switches 144 and 142 are connected to the T₁ and T₂ terminals whereas, in step-down mode, they are connected to the T₃ and T₄ terminals. Accordingly, in step-up mode T₁, T₂ will be fired at 0 and 180 degrees respectively whilst, in step-down mode, T₃, T₄ will be fired at 0 and 180 degrees respectively.

The converter of FIG. 13 has been tested using the test system data of tables 2 to 4.

FIGS. 15a to 15c show the simulation responses of the converter of FIG. 13. It can be seen that the converter follows the current reference very well (at 0.2 s and 0.3 s), that the converter shows good robustness to substantial V₁ and V₂ voltage disturbance (at 0.6 s, 0.7 s. 0.8 s and 0.9 s), and that rapid change in power direction is achieved (at 0.4 s and 0.5 s), by changing the polarity of the currents I₁ and I₂ in the low and high voltage circuits.

FIGS. 16a to 16d show detailed traces for step-up and step-down mode operation of the converter.

In step-up mode, the peak capacitor voltage is close to V₂ since the thyristors T₅, T₆ conduct as V_{c}>V₂. In step-down mode, the peak capacitor voltage V_{c} is higher because of earlier firing of T₇ and T₈ in order to ensure sufficient turn off time.

The opposite polarity of the low voltage circuit current I₁ can be seen in FIG. 16b.

Faults are of extreme importance in high-power electronics, because they create excessive currents and may cause high overvoltages. Unlike low power electronics, component costs are very high, and it is not economically justifiable to significantly overrate components in order to withstand fault conditions.

There are no commercially accepted DC circuit breakers in high power electrical systems. Instead, DC faults are generally cleared with AC-side circuit breakers. Alternatively, in some circumstances, converters may be designed to operate under fault conditions (rectifiers only).

If a fault occurs at one set of terminals of a DC-DC converter, there are several possible undesirable effects.

In this respect, the unfaulted side may feed fault current through the converter to the fault location. The fault is thus propagated through the converter. Further, the unfaulted side may develop short circuit (shot-through on a converter branch). When this happens, the voltage on the other side is reduced to zero. The central cause of these problems is that the circuit allowed turn off time (T_{offmax1} for low voltage circuit or T_{offmax2} for high voltage circuit) becomes shorter than the switch turn off time (T_{off}) and a thyristor fails to provide forward blocking. The converter may also develop excessive overvoltages, or overcurrents even if it rides through the fault.

The topologies presented in FIGS. 6 and 13 inherently possess relatively good fault tolerance. However they can suffer all of the above issues in the case of unfavourably located or extreme faults.

There are four possible fault combinations:—
A. Fault on V₁ for step-up operation (V₁ to V₂ transfer)
B. Fault on V₂ for step-up operation (V₁ to V₂ transfer)
C. Fault on V₁ for step-down operation (V₂ to V₁ transfer)
D. Fault on V₂ for step-down operation (V₂ to V₁ transfer)

Faults A and D are trivial since they occur “upstream” of the converter power flow, and they will only interrupt power transfer through the converter. Faults B and C, however, are known to disturb the operation of typical converters.

Analytical and simulation studies show that fault C is well tolerated by the converter. In worst cases, ie low stepping ratio (V₂/V₁=3), the reduction in T_{offmax1} is around 20%. Such small margin can be readily incorporated by reducing the switching frequency in equation (8) and marginally increasing L₁. The peak current during fault C will typically be 20% higher than the nominal current. The peak capacitor voltage remains unchanged.

Therefore, a small margin in selecting operating frequency will enable the converter to retain controllability through fault C, and the overcurrent will be insignificant. For a permanent fault, the controller can gradually reduce the operating frequency and block the switches altogether.

A fault of type B will have more impact on the waveform of the converter variables. The circuit turn off time T_{offmax1} will be much shorter and it will depend on the parameters in the high voltage circuit. With some approximations, it can be shown that the two design equations during V₂ fault are:

T_{offmax1}=π√(L₁Cᵣ)·(1−α₂ᵤₚ/π)+½π·√(L₂Cᵣ) (35)

I₂=V_{cp}√(Cr/(4L₂))·sin(ω₂t) (36)

By setting the desired T_{offmax1} and I₂ₚₑₐₖ, the values for α₂ᵤₚ and L₂ can be determined. Since α₂ᵤₚ can not be manipulated much (it causes overvoltages), the main design strategy is the increase in the high voltage inductor L₂.

A full controllability for most severe V₂ faults can be maintained, and the fault current can be limited by selecting L₂ sufficiently high to satisfy (35) and (36). In practice, since equations (35) and (36) are approximate, a trial and error method on the digital simulator can give optimal values for L₂. The finally obtained values for L₂ with the test studies are reasonably small and for the considered test system in table 2 it increases from 0.3 mH to 0.7 mH.

The values for L₂ obtained above considering fault conditions are somewhat larger than the optimal values calculated as shown in FIG. 10. Therefore, there will be some compromise in terms of performance which is reflected in increased peak capacitor voltage or reduced operating frequency.

In cases where the increase in L₂ requires large compromise in performance, an alternative design method is to use two L₂ inductors. An optimal L_{2down} can be calculated as in FIG. 10 and connected to the switches used in step down mode. Another L₂ᵤₚ can be calculated using equations (35) and (36) and connected to the switches employed in step up mode.

The inherent converter response to faults in a short post-fault interval is considered above. An additional control circuit may also be required for interrupting power transfer during prolonged or permanent faults. A suitable control circuit 170 is shown in FIG. 17. In the control circuit 170, the output current reference I_{1rof} is connected to the I_{1ref} signal in the control system of FIG. 7 or FIG. 14. I_{1ref0} becomes the set current value (I_{1ref0}=1.29 kA). The current reference signal is made dependent on the terminal voltage which is measured through a low pass filter and passed through a non-linear element. If the terminal voltage drops below some low value (say 30 kV for V₂ or 1 kV for V₁), the current reference is reduced to zero and the power through the converter is interrupted. For less severe faults the converter operates with reduced current. The control unit 172 in FIG. 17 (block converter 2) provides direct blocking of the high voltage side of the converter in order to reduce overvoltages in the case of the most severe faults at high-voltage side.

Table 8 specifies values for the converter parameters for a bidirectional converter that has been designed to achieve immunity from most severe faults. These values are closely based on the test system specified in tables 2 to 4 above. However, the size of the inductor L₂ is increased to 0.7 mH and the filter values are slightly modified.

It is noted that the faults which have higher impedance (like remote faults where the terminal voltage during fault is retained at, for instance, over 50%), which are, in practice, most common, are readily tolerated without any modifications or additional control logic. The controller of FIG. 17 is only required for prolonged and very severe B and C-type faults.

FIGS. 18a to 18f show the results of a PSCAD simulation of the most severe fault scenario, namely a zero-impedance transient fault at the V₂ terminals during step-up operation (fault B). FIG. 18c indicates that V₂ reduces to zero for 0.1 s. FIG. 18f shows that the converter current increases immediately after the fault, but that after 30-40 ms the controller reacts and the power transfer is interrupted. The fault is not propagated to the V₁ terminals because current I₁ reduces to 0 as can be seen from FIG. 18a. It can thus be concluded that a fault on one side of the converter represents an open circuit on the other side. The recovery from fault after the voltage is reestablished is also very fast, without transient overvoltages. The overvoltages expected are in the order of 20-30%.

FIGS. 19a to 19f shows the results of a simulation of a further difficult fault scenario, where the voltage V₁ reduces to zero during step-down operation (fault C). It can be seen that the responses shown here indicate fast recovery from the fault.

FIGS. 20a and 20b and FIGS. 21a and 21b respectively show the results of simulation of faults on the power exporting side, which the converter naturally rides through (faults A and D).

FIGS. 22a and 22b show a high-impedance fault of type C, where the voltage V₂ reduces to around 45 kV. In this case the converter maintains power transfer (at a reduced level), since the power in-feed may be important for maintaining the stability of the faulted circuit.

TABLE 8
Test System Data for Fault Interruption

| Parameter | Value | | Resistance |
|---|---|---|---|
| V₁ | 4 | kV | / |
| V₂ | 80 | kV | / |
| P₂ | 5 | MW | / |
| fₛ | 1000 | Hz | / |
| Cᵣ | 7.9 | μF | R_{cr} = 1 MΩ |
| L₁ | 12 | mH | R_{L1} = 15 mΩ |
| L₂ | 0.7 | mH | R_{L2} = 5 mΩ |
| α_{B} | 112° | | / |
| L_{f1} | 5 | mH | R_{Lf1} = 8 mΩ |
| C_{f1} | 200 | μF | R_{Cf1} = 1 MΩ |
| L_{f2} | 25 | mH | R_{Lf2} = 20 mΩ |
| C_{f2} | 100 | μF | R_{Cf2} = 1 MΩ |

For reasons of economy and convenience, it is desirable to reduce the size and weight of the inductor L₁. Whilst a sufficiently large value inductor L₁ will be required for the purposes of fault prevention, other constraints on the design of the converter typically mean that the value of L₁ will be significantly higher than that required for fault prevention, such that a reduction in the size and weight of the inductor would not affect the fault tolerance of the converter.

The size and weight of the inductor L₁ may be decreased by increasing the operating frequency fₛ of the circuit. However, the maximum operating frequency fₛₘₐₓ is limited by the turn off time for the thyristors.

To achieve a higher operating frequency, it is therefore necessary for the inductor L₁ to supply multiple capacitors in a sequence, instead of a single capacitor Cᵣ. In order to connect multiple capacitors, additional converter branches are required.

The maximum inductor frequency fₛₘₐₓ, is related to the number of converter branches n_{b} by equation (37).

fₛₘₐₓ=(2(n_{b}−2)+1)/2T_{off} (37)

where T_{off} is the thyristor turn off time.

In the circuits of FIGS. 6 and 13, n_{b}=2, ie, the converters are 2-branch converters, since the thyristors in the low and high voltage circuits are respectively arranged into two branches Bₐ, B_{b}.

From equation (37) it can be seen that by adding a single branch such that n_{b}=3, the operating frequency fₛₘₐₓ will be increased by three times. Further, by doubling the number of branches such that n_{b}=4, the operating frequency on the inductor is increased by five times.

Where n_{b}>2, a capacitor will be connected between each branch and every other branch. Thus, for a 3-branch converter, comprising three branches Bₐ, B_{b}, and B_{c}, a first capacitor will be connected between branch Bₐ and branch B_{b}, a second capacitor will be connected between branch Bₐ and branch B_{c}, and a third capacitor will be connected between branch B_{b} and branch B_{c}.

In general, the number of capacitors n_{c} required is related to the number of branches n_{b} by equation (38):

n_{c}=n_{b}(n_{b}−1)/2 (38)

Accordingly, the number of capacitors n_{c} increases faster than the operating frequency fₛₘₐₓ. It is therefore likely that cost factors will imply an optimum number of branches for a particular design.

In general, adding converter branches will result in a more complex circuit and will require additional capacitors. However, the additional cost and complexity can be balanced against the consequent reduction in the size, and thus the cost, of the inductor L₁.

FIG. 23 shows the topology for a 3-branch bidirectional converter in Delta capacitor connection. Y-connection of the capacitors Cᵣ, as illustrated in FIG. 24 is also possible.

The converter 230 of FIG. 23 is similar to that of the converter 130 of FIG. 13, except that the low and high voltage circuits 232, 234 each comprise four additional thyristors, and the circuits are linked by 2 additional capacitors Cᵣ.

In the low voltage circuit 232, the 12 thyristors are arranged as three branches Bₐ, B_{b} and B_{c}.

Again, each branch in each circuit has two DC terminals, and one AC terminal. The branch is connected across the respective voltage terminals by the two DC terminals. The capacitor Cᵣ is connected to the AC terminal of each branch, ie, the central terminal between the two thyristor switches of each branch. This connection allows alternating capacitor current.

In the thyristor labelling used in FIGS. 23 and 25, the first subscript refers to the side of the converter (1=low voltage side, 2=high voltage side); the second subscript refers to the branch (a=branch Bₐ, b=branch B_{b} c=branch B_{c}); the third subscript refers to the mode in which the thyristor is operational (u=up, d=down); and the fourth subscript refers to the polarity, (p=positive, n=negative).

Branch Bₐ comprises a first pair of series connected thyristors T₁ₐᵤₚ and T₁ₐᵤₙ for operation in step-up mode, and a second pair of series connected thyristors T_{1adp} and T_{1adn}, connected in anti-parallel with the first pair, for operation in step-down mode. Branches B_{b} and B_{c} are similarly configured. Each set of two anti-parallel thyristors constitutes a bidirectional switch.

A first one of the capacitors Cᵣ is connected between a central terminal of branch Bₐ, and a correspondingly located central terminal on branch B_{b}. A second capacitor is similarly connected between branch Bₐ and branch B_{c}, and a third is similarly connected between branch B_{b} and branch B_{c}.

The high voltage circuit 234 is configured in a corresponding manner to the low voltage circuit 232. The capacitors are respectively connected between the same pairs of branches Bₐ-B_{b}, Bₐ-B_{c}, B_{b}-B_{c} in the high voltage circuit as in the low voltage circuit.

Circuits with higher numbers of branches can be readily developed by providing additional capacitors Cᵣ, such that there is a capacitor connected between each branch and every other branch

FIG. 25 shows a control system 250 for controlling the operation of the circuit 230 of FIG. 23, by controlling the firing of the thyristor switches. The control system 250 is suitable when the capacitors Cᵣ are arranged in either Delta connection, as shown in FIG. 23, or Y connection, as shown in FIG. 24. The same control structure applies to both the high and low voltage circuits 232, 234, identified as converter 1 and converter 2 in FIG. 25. If used with converter 1, the switch 252 labelled “conv ½” is in its up position. With converter 2, this switch is in its down position.

Switch 252 allows the thyristors T₁ₓₓₓ in the low voltage circuit 232 to be fired at an angle θ_{c}=0. Thus, the converter with the higher current I₁ operates with no zero-current intervals. The high voltage circuit 234 carries lower current and has shorter conduction intervals, meaning there is freedom in choosing the firing instant α₂.

As can be seen from FIG. 25, the thyristors are fired in a sequence that maximizes the turn-off time for each thyristor. This is achieved by maximizing the interval between switching instants for the two thyristors on the same branch. For example, T₁ₐᵤₚ and T₁ₐᵤₙ. Each thyristor is consequently fired to supply all capacitors to which it is connected. Thus, for example, T₁ₐᵤₚ twice in sequence at 0° and 60°. In the following cycles, T_{1bun} and T_{1cun} (ie, all the thyristors on the opposite pole) are fired before the thyristor in same branch, T₁ₐᵤₙ, is fired.

The actual firing sequence and the turn-off time are illustrated in detail in relation to the practical 3-branch converter simulation results in FIG. 27.

The values for the inductor L₂ and the firing angles for the high voltage circuit (α₂ᵤₚ=0 and α_{2down}) and any further circuits, can be selected using the principles outlined above.

A 3-branch Delta connected/Y connected converter with the same power transfer requirements as the test system described above has been simulated.

The simulated converter is designed to enable fast responses, good robustness to disturbances at the high and low voltage terminals, fast power reversal capability, and to have complete fault tolerance even for the worst case faults described above.

Table 9 gives values for the parameters of the simulated 3-branch converter compared with those for a corresponding 2-branch converter. The inductor L₁ is around 4 times smaller (in either Delta or Y connection) compared with the 2-branch converter, which represents a significant reduction in inductor size. It should be noted, however, that more switches and capacitors are required and the operating voltage is increased, as compared with the circuits of FIGS. 6 and 13.

The thyristors have a lower average current than with the circuits of FIGS. 6 and 13, since current is split between three branches. The Delta connection has an advantage over Y connection in terms of capacitor size, although the capacitor voltage is higher.

TABLE 9
Comparison Data for 2 and 3-Branch Converters

| | | 3 Branch | 3 Branch |
|---|---|---|---|
| | 2 Branch | Delta | Y |
| fₛ [Hz] | 1000 | 3000 | 3000 |
| Cᵣ [μF] | 7.9 | 2.4 | 6.8 |
| No of Cᵣ | 1 | 3 | 3 |
| V_{cmax} [kV] | 110 | 150 | 80 |
| L₁ [mH] | 12 | 2.9 | 3.2 |
| V_{L1max} [kV] | 100 | 80 | 80 |
| L₂ [mH] | 5 | 0.2 | 0.2 |
| No of Thyristors | 4 | 6 | 6 |
| V_{dr}/Vᵣᵣ | 110 | 150 | 150 |
| Iₜₕ [A] | 670 | 440 | 440 |
| C_{f1} [μF] | 200 | 100 | 100 |
| L_{f1} [mH] | 5 | 2 | 2 |
| C_{f2} [μF] | 100 | 150 | 150 |
| L_{f2} [mH] | 25 | 20 | 20 |
| α₂ᵤₚ [deg] | 180 | 190 | 183 |
| α_{2down} [deg] | 112 | 116 | 116 |

FIGS. 26a to 26d show simulation results for a Delta connected 3-branch converter. Power reversal at 0.1 s is simulated (as the most demanding performance test) and a most onerous fault on V₂ is applied at 0.3 s. It can be seen that the converter shows excellent performance and excellent resilience to faults. Also the overvoltage on the components during the fault is only of the order of 20-30%.

The I₂ current oscillation during the fault seen in FIG. 26b has zero average value and only represents oscillation with the filter capacitor.

FIGS. 27a and 27b show detailed traces for step-up operation of the converter of FIG. 23. The capacitor voltage V_{c} has a distorted sinusoidal shape. Since the voltage V_{c} has a narrow waveform closer to the peaks, the available turn off time for the thyristors will be shorter. As a result, it is necessary to operate at higher capacitor voltages, approaching twice the value of the voltage V₂ at the high voltage terminals (see table 10). If only step-up operation is required the capacitors may operate at a voltage V_{c} close to V₂.

FIGS. 27a and 27b also show the thyristor firing sequence and the turn off time T_{off1aup} for thyristor T₁ₐᵤₚ. The available turn off time is the interval between thyristor turn off and the instant of forward voltage bias, which occurs on the middle point in the next conducting interval for the thyristor connected to the opposite pole on the same branch, T₁ₐᵤₙ. It can be seen that the turn off interval is T_{off}=3/2Tₛ which is 3 times larger than with the 2-branch converters discussed above, where T_{off}=Tₛ/2. This means that the operating frequency fₛ can be increased by three times, over that possible with a 2-branch converter.

FIGS. 28a to 28c show the PSCAD simulation results for a 3-branch Y connected converter. These graphs illustrate that excellent performance and excellent fault tolerance are obtained. In particular, the fault current is fast interrupted and the overvoltage is very low.

FIGS. 29a and 29b show detailed voltage and current traces for a Y connected 3-branch converter. These illustrate that the capacitor voltage is much lower than in case of Delta-connection, but that the thyristor peak voltage (both reverse and forward) is similar and close to 2V₂.

With the converter 230 of FIG. 23, the branches in both the low and high voltage circuits 232, 234, comprise bidirectional switches (ie, two thyristors connected together in antiparallel). This allows the current direction to be reversed in either or both of the low and high voltage circuits by switching between the switches that compose the bidirectional switch. However, in cases where the ability to reverse the current direction in either or both circuits is not required, for example, where the voltage polarity at the respective terminals can be changed, unidirectional switches may be provided in the respective circuit(s). That is to say, the set of switches T_{xxdx} or Tₓₓᵤₓ may be omitted in either or both of the low and high voltage circuits. In this case, the switches 254 in the control circuit 250 of FIG. 25 would be omitted for either or both of “Converter 1” and “Converter 2”. Instead, the output terminal of the respective or gate would be permanently connected to the terminals of the remaining switches.

Other than the aforementioned differences, the description and analysis of the converter of FIG. 24 applies equally to these alternative embodiments. In particular, the principles relating the operating frequency, the number of branches and the number of capacitors apply equally with these alternative embodiments, and the selection of the firing angles in the low and high voltage circuits to achieve step-up and step-down modes also applies.

In general, the present invention has been described in terms of bidirectional converters in which the direction of current flow can be changed in the low and/or the high voltage circuit. However, the principles for achieving step-up and step-down operation by selective switching of the switches in the high voltage circuit may be applied to a converter in which reversal of current direction is not possible in either circuit.

For example, a bidirectional converter in which the direction of power transfer may be reversed by reversing the voltage polarity at both the high and low voltage terminals, or even a unidirectional step-up or step-down converter. Such a converter is illustrated in FIG. 30, and a suitable controller for this circuit is illustrated in FIG. 31. The converter is similar to that of FIG. 6, except that the second set of switches in the high voltage circuit is omitted. With this converter, the switches allow current flow at the respective voltage terminals in only one direction. However, power transfer reversal can be achieved by reversing the voltage polarity at either the low or high voltage terminals.

Similarly, the principles for increasing the maximum switching frequency, by increasing the number of capacitors and converter branches may be applied to a converter in which reversal of current direction is not possible in either circuit. For example, a bidirectional converter in which the direction of power transfer may be reversed by reversing the voltage polarity at both the high and low voltage terminals, or even a unidirectional step-up or step-down converter.

The present invention has been described in terms of a converter for transferring power from low voltage terminals to high voltage terminals. It will be appreciated however, that the voltage at the low and high voltage terminals may be substantially equal, ie V₁=V₂. For example, where the converter is used as a fault current limiter where voltage stepping is not required, or for regulation of V₂, where V₂ is at a similar level as V₁.

### REFERENCES

[1] D. K. Choi, at all. “A novel power conversion circuit for cost effective battery fuel cell hybrid system” Elsevier Journal of Power Sources, Vol 152, (2005), pp 245-255.
[2] L. Heinemann “Analysis and design of a modular, high power converter with high efficiency for electrical power distribution systems” IEEE PESC 2002, Volume: 2, pp 713-718.
[3] D. Jovcic “Off Shore Wind Farm with a Series Multiterminal CSI HVDC” Electric Power Systems Research, Elsevier, Vol 78, issue 4, 2008, pp 747-755.
[4] Kjell Ericsson “Operational Experience of HVDC Light” Seventh International Conference on AC-DC Power Transmission. IEE. 2001, pp. 205-210. London, UK.
[5] N. Mohan, T M. Undeland, W P. Robbins, “Power Electronics Converters, Applications and Design,” John Wiley & Sons, 1995.
[6] R J. Wai, R Y Duan, “High step-up converter with coupled inductor” IEEE Transactions on Power Electronics, vol 20, no 5, September 2005, pp 1025-1035.
[7] Q. Zhao, F. C. Lee “High Efficiency, high step-up DC-DC converters” IEEE Transactions on Power Electronics, Vol 18, no 1, January 2003, pp 65-73.
[8] K. Hirachi at all. “Circuit configuration of bi-directional DC/DC converter specific for small scale load leveling system” Proc. IEE Power conversion conference, 2002, pp 603-609.
[9] O. Abutbul, at all “Step-up Switching Mode Converter With High Voltage Gain Using a Switched-Capacitor Circuit” IEEE Transactions On Circuit and Systems-I Vol. 50, no 8. August 2003, pp 1098-2002.
[10] V. Ranganathan, P. D. Ziogas and V. Stefanovic “A regulated DC-DC Voltage source converter using a high frequency link” IEEE Transactions on Industry applications, Vol 18, no 3, May/June 1982, pp 279-287.
[11] D. Jovcic, “Phase Locked Loop System for FACTS” IEEE Transactions on Power Syst, Vol 18, no 3, August 2003, pp 1116-24.
[12] Manitoba HVDC Research Center “PSCAD/EMTDC users manual,” Winnipeg 2003.

1-55. (canceled)

56. A DC-DC power converter (130) for transferring power from low voltage terminals (26) to high voltage terminals (28), and/or for transferring power from high voltage terminals (28) to low voltage terminals (26), the converter comprising:—
a low voltage circuit (132) connectable to the low voltage terminals (26);
a high voltage circuit (134) connectable to the high voltage terminals (28); and
at least one capacitor (Cr) common to the low and high voltage circuits;
wherein each of the low and high voltage circuits comprises an inductor (L1/L2) and a plurality of switches (T1-T4/T5-T6) arranged to connect the respective inductor in series with the or each capacitor, and to alternate the polarity with which the or each capacitor is connected to the respective inductor, to form a resonant LC connection across the respective voltage terminals;
wherein the plurality of switches in each of the low and high voltage circuits include at least one set of switches (T1,T2/T5,T6) which, when actuated, allow current flow at the respective voltage terminals in a first direction;
and wherein the switches in at least one of the low and high voltage circuits include a further set of switches (T3,T4/T7,T8), which, when actuated, allow current flow at the respective voltage terminals in a second direction;
the converter further comprising:—
selecting means (72/74) for selecting one of the sets of switches (T1,T2/T3,T4) in the or each circuit (132/134) where two sets of switches are provided, to select the direction of current at the respective voltage terminals (26/28), and thereby control the direction of power transfer between the high and low voltage terminals;
control means (140,142) for actuating the set of switches (T1,T2) or the selected set of switches (T1,T2/T3,T4) in the low voltage circuit (132) at a predetermined frequency and at predetermined phase angle(s), to repeatedly connect the capacitor, or each capacitor in turn, to the respective inductor (L1) with alternating polarity, to thereby allow power transfer from the low voltage terminals to the capacitor(s), and/or to allow power transfer from the capacitor(s) to the low voltage terminals; and
control means (140,144) for actuating the set of switches (T5,T6) or the selected set of switches (T5,T6/T7,T8) in the high voltage circuit (134) at a predetermined frequency and at predetermined phase angle(s), to repeatedly connect the capacitor, or each capacitor in turn, to the respective inductor (L2) with alternating polarity, to thereby allow power transfer from the capacitor(s) to the high voltage terminals and/or to allow power transfer from the high voltage terminals to the capacitor(s).

57. A converter as claimed in claim 56 wherein the low and high voltage circuits both include two sets of switches.

58. A converter as claimed in claim 56 wherein, where two sets of switches are present in a circuit, the two sets of switches comprise two sets of unidirectional switches connected together in antiparallel.

59. A converter as claimed in claim 56 wherein, where two sets of switches are present in a circuit, the two sets are composed of bidirectional switches, each bidirectional switch being actuable as a switch from the first set, to allow current flow at the respective terminals in a first direction, and actuable as a switch from the second set, to allow current flow at the respective terminals in a second direction.

60. A converter as claimed claim 56 wherein the switches of both the low and high voltage circuits are connected in the respective circuit as two or more parallel branches, each branch comprising at least one pair of unidirectional switches connected together in series with the same orientation, and where the branches connect the inductor with the respective voltage terminal, wherein each branch in one of the low and high voltage circuits comprises a single pair of unidirectional switches.

61. A converter as claimed in claim 60 wherein each branch in one or both of the low and high voltage circuits comprises a first pair of series connected unidirectional switches connected in antiparallel with a second pair, to form a pair of bidirectional switches connected together in series.

62. A converter as claimed in claim 56 wherein the converter has nb branches in each circuit (where nb>1) and nc capacitors connected between central terminals of the branches (where nc1), and wherein the number of branches is related to the number of capacitors by equation (38):
nc=(nb−1)nb/2 (38)

63. A converter as claimed in claim 62 wherein nb=2, and wherein the low and high voltage circuit switches are respectively arranged as a first branch and a second branch, the single capacitor being connected between central terminals of the first and second branches in each circuit.

64. A converter as claimed in claim 62 wherein nb=3, and wherein the switches of the low and high voltage circuits are respectively arranged as first, second and third branches, a first capacitor being connected between central terminals of the first and second branches in each circuit, a second capacitor being connected between central terminals of the first and third branches in each circuit, and a third capacitor being connected between central terminals of the second and third branches in each circuit.

65. A converter as claimed in claim 62 wherein a capacitor is connected between each branch and every other branch in the low voltage circuit, the or each capacitor being connected between central terminals of corresponding pairs of branches in the high voltage circuit.

66. A converter as claimed claim 62 wherein the maximum switching frequency fsmax is related to the number of branches by equation (37):
fsmax=(2(nb−2)+1)/2Toff (37)
where Toff is the maximum turn off time for the switches.

67. A DC-DC power converter (300) for transferring power from low voltage terminals (26) to high voltage terminals (28), and/or for transferring power from high voltage terminals (28) to low voltage terminals (26), the converter comprising:—
a low voltage circuit (302) connectable to the low voltage terminals (26);
a high voltage circuit (304) connectable to the high voltage terminals (28); and
at least one capacitor (Cr) common to the low and high voltage circuits;
wherein each of the low and high voltage circuits comprises an inductor (L1/L2) and a plurality of switches (T1,T2/T5,T6) arranged to connect the respective inductor in series with the or each capacitor, and to alternate the polarity with which the or each capacitor is connected to the respective inductor, to form a resonant LC connection across the respective voltage terminals;
the converter further comprising:—
control means (310, 312) for actuating the switches in the low voltage circuit (302) at a predetermined frequency and at predetermined phase angle(s), to repeatedly connect the capacitor, or each capacitor in turn, to the respective inductor (L1) with alternating polarity, to thereby allow power transfer from the low voltage terminals to the capacitor(s) in a first mode of operation, and/or to allow power transfer from the capacitor(s) to the low voltage terminals in a second mode of operation; and
control means (310, 314) for actuating the switches in the high voltage circuit (304) at a predetermined frequency and at predetermined phase angles, to repeatedly connect the capacitor, or each capacitor in turn, to the respective inductor (L2) with alternating polarity, to thereby allow power transfer from the capacitor(s) to the high voltage terminals and/or to allow power transfer from the high voltage terminals to the capacitor(s).

68. A converter as claimed in claim 67 wherein the switches in each of the high and low voltage circuits comprise unidirectional switches which, when actuated, allow current flow in a single direction at the respective voltage terminals.

69. A converter as claimed in claim 67 wherein the switches of both the low and high voltage circuits are connected in the respective circuit as two or more parallel branches, each branch comprising at least one pair of unidirectional switches connected together in series with the same orientation, and each branch connecting the inductor with the respective voltage terminal.

70. A converter as claimed in claim 67 wherein the converter has nb branches in each circuit (where nb>1) and nc capacitors connected between the branches (where nc1), and wherein the number of branches is related to the number of capacitors by equation (38):
nc=(nb−1)nb/2 (38)

71. A converter as claimed in claim 70 wherein nb=2, and wherein the low and high voltage circuit switches are respectively arranged as a first branch and a second branch, the single capacitor being connected between the first and second branches in each circuit.

72. A converter as claimed in claim 70 wherein nb=3, and wherein the switches of the low and high voltage circuits are respectively arranged as first, second and third branches, a first capacitor being connected between central terminals of the first and second branches in each circuit, a second capacitor being connected between central terminals of the first and third branches in each circuit, and a third capacitor being connected between central terminals of the second and third branches in each circuit.

73. A converter as claimed in claim 70 wherein a capacitor is connected between central terminals of each branch and every other branch in the low voltage circuit, the or each capacitor being connected between central terminals of corresponding pairs of branches in the high voltage circuit.

74. A converter as claimed claim 70 wherein the maximum switching frequency fsmax is related to the number of branches by equation (37):
fsmax=(2(nb−2)+1)/2Toff (37)
where Toff is the maximum turn off time for the switches.

75. A DC-DC power converter (230) for transferring power from low voltage terminals (26) to high voltage terminals (28), and/or for transferring power from high voltage terminals (28) to low voltage terminals (26), the converter comprising:—
a low voltage circuit (232) connectable to the low voltage terminals (26);
a high voltage circuit (234) connectable to the high voltage terminals (28); and
nc capacitors (Ca, Cb, Cc) common to the low and high voltage circuits;
wherein each of the low and high voltage circuits comprises an inductor (L1/L2) and a plurality of switches (T1xxx/T2xxx) arranged to connect the respective inductor in series with each capacitor in turn, and to alternate the polarity with which each capacitor is connected to the respective inductor, to form a resonant LC connection across the respective voltage terminals;
the converter further comprising:—
control means (250) for actuating the switches in the low voltage circuit at a predetermined frequency and at predetermined phase angle(s), to repeatedly connect each capacitor in turn to the respective inductor (L1) with alternating polarity, to thereby allow power transfer from the low voltage terminals to the capacitors in a first mode of operation, and/or to allow power transfer from the capacitors to the low voltage terminals in a second mode of operation; and
control means (250) for actuating the switches in the high voltage circuit at a predetermined frequency and at predetermined phase angle(s), to repeatedly connect each capacitor in turn to the respective inductor (L2) with alternating polarity, to thereby allow power transfer from the capacitors to the high voltage terminals and/or to allow power transfer from the high voltage terminals to the capacitors;
wherein nc is greater than one.

76. A converter as claimed in claim 75 wherein the number of branches is related to the number of capacitors by equation (38):
nc=(nb−1)nb/2 (38)

77. A converter as claimed in claim 75 wherein the switches in each of the low and high voltage circuits include at least one set of switches which, when actuated, allow current flow at the respective voltage terminals in a first direction, and wherein the switches in at least one of the low and high voltage circuits include a further set of switches which, when actuated, allow current flow at the respective voltage terminals in a second direction; and wherein the control means is configured to select for actuation one of the sets of switches for the or each circuit where two sets are present, to select the direction of current flow at the respective terminals.

78. A converter as claimed in claim 75 wherein the low and high voltage circuits both include two sets of switches.

79. A converter as claimed in claim 75 wherein, where two sets of switches are present in a circuit, the two sets of switches comprise two sets of unidirectional switches connected together in antiparallel.

80. A converter as claimed claim 75 wherein, where two sets of switches are present in a circuit, the two sets are composed of bidirectional switches, each bidirectional switch being actuable as a switch from the first set, to allow current flow in a first direction at the respective voltage terminals, and actuable as a switch from the second set, to allow current flow in a second direction at the respective voltage terminals.

81. A converter as claimed in claim 75 wherein switches are configured in parallel branches, and each branch comprises at least one pair of unidirectional switches connected together in series with the same orientation, where each branch is connected between the inductor and the respective voltage terminal, and the capacitors are connected between central terminals of the branches.

82. A converter as claimed in claim 75 wherein each branch in one of the low and high voltage circuits comprises a single pair of unidirectional switches.

83. A converter as claimed in claim 79 wherein each branch in one or both of the low and high voltage circuits comprises a first pair of series connected unidirectional switches connected in antiparallel with a second pair, to form a pair of bidirectional switches connected together in series.

84. A converter as claimed in claim 75 wherein nb=3, and wherein a first capacitor is connected between central terminals of the first and second branches in each circuit, a second capacitor being connected between central terminals of the first and third branches in each circuit, and a third capacitor being connected between central terminals of the second and third branches in each circuit.

85. A converter as claimed in claim 75 wherein a capacitor is connected between central terminals of each branch and every other branch in the low voltage circuit, the or each capacitor being connected between central terminals of corresponding pairs of branches in the high voltage circuit.

86. A converter as claimed in claim 75 wherein the maximum switching frequency fsmax is related to the number of branches by equation (37):
fsmax=(2(nb−2)+1)/2Toff (37)
where Toff is the maximum turn off time for the switches.

87. A converter as claimed in claim 56, further comprising fault control means for interrupting or limiting power transfer during a fault at either or both of the low and high voltage terminals.

88. A converter as claimed in claim 56, where the inductor in the low voltage circuit and/or the inductor in the high voltage circuit are selected to provide sufficient time for thyristor turn off under fault conditions and thereby to provide normal controllable converter operation during faults at either of the terminals.

89. A converter as claimed in claim 56 wherein the high voltage circuit comprises a first inductor for use when transferring power in the first direction, and a second inductor for use when transferring power in the second direction.

90. A converter as claimed in claim 56, wherein the low voltage circuit and/or the high voltage circuit comprises a filter circuit, wherein the or each respective filter circuit comprises an LC filter comprising a filter inductor and a filter capacitor connected across the low voltage terminals.
